(19) United States
(12) Patent Application Publication
(10) Pub. No.: US 2019/0301212 A1
(43) Pub. Date: Oct. 3, 2019

(54) CLOSURE LATCH ASSEMBLY WITH LATCH MECHANISM HAVING A DUAL-PAWL CONFIGURATION

(71) Applicant: Magna BOCO GmbH, Wuppertal (DE)

(72) Inventors: Michael DIGEL, Wuppertal (DE); Vladmir LEBSAK, Wuppertal (DE)

(21) Appl. No.: 16/363,272

(22) Filed: Mar. 25, 2019

Related U.S. Application Data
(60) Provisional application No. 62/648,646, filed on Mar. 27, 2018.
(60) Provisional application No. 62/689,393, filed on Jun. 25, 2018.

(51) Int. Cl. E05B 81/16; E05B 77/04; E05B 85/26; E05B 81/36; E05B 81/42; E05B 81/20; E05B 81/90

(52) U.S. Cl. CPC E05B 81/16; E05B 77/04; E05B 85/26; E05Y 2900/531; E05B 81/42; E05B 81/20; E05B 81/90; E05B 81/36

(57) ABSTRACT

A closure latch assembly for installation in the door of a motor vehicle. The closure latch assembly is equipped with a primary latch mechanism, a latch release mechanism, a secondary latch mechanism, and a power actuation mechanism. The latch release mechanism is controlled by the power actuation mechanism to release the primary latch mechanism and provide a power release function. The secondary latch mechanism is configured to block the primary latch mechanism from unintentional release. The power actuation mechanism controls the secondary latch mechanism to unblock the primary latch mechanism prior to release thereof via the latch release mechanism.

### CROSS-REFERENCE TO RELATED APPLICATION

This application claims the benefit of U.S. Provisional Application Ser. No. 62/648,646, filed Mar. 27, 2018, and U.S. Provisional Application Ser. No. 62/689,393 filed Jun. 25, 2018, which are incorporated herein by reference in their entirety.

### FIELD

The present disclosure relates generally to a closure latch assembly for installation in a vehicle door and, more particularly, to a closure latch assembly having a primary latch mechanism, a secondary latch mechanism, and a power-operated latch release mechanism providing a power release function with a soft opening feature.

### BACKGROUND

This section provides background information related to closure latch assemblies of the type used in motor vehicles as part of a door closure system and which is not necessarily prior art to the inventive concepts embodied in the present disclosure.

In view of increasing consumer demand for motor vehicles equipped with advanced comfort and convenience features, many modern motor vehicles are now provided with a passive keyless entry (PKE) system to permit remote locking/unlocking and release of closure panels (i.e. passenger doors, decklids, tailgates, liftgates, etc.) without the use of a traditional key-type entry system. In this regard, some popular features now available in association with vehicle closure latch systems include power locking/unlocking and power release. These “powered” features are provided by a closure latch assembly mounted to the closure panel and equipped with a latch mechanism and a power-operated latch release mechanism. Typically, the latch mechanism is configured to include a ratchet operable in a striker capture position to releaseably retain a striker (mounted to a structural portion of the vehicle) for holding (i.e. “latching”) the closure panel in a closed position. The ratchet is mechanically held in its striker capture position by a pawl configured to engage the ratchet when the pawl is located in a ratchet holding position. For subsequently releasing (i.e. “unlatching”) the closure panel to allow movement from its closed position toward an open position, the power-operated latch release mechanism is actuated for moving the pawl from its ratchet holding position into a ratchet releasing position. Once the pawl is located in its ratchet releasing position, a ratchet biasing arrangement and the seal loads acting on the ratchet to forcibly move the ratchet from its striker capture position into a striker release position. Typically, a power release actuator, such as an electric motor and motor-driven power release gearset, is employed to selectively actuate and reset the latch release mechanism.

To prevent precipitation and road debris from entering the vehicle, virtually all closure panels are equipped with a resilient weather seal around its peripheral edge and which is configured to seal against a mating surface of the vehicle body. The weather seal is also functional to reduce wind noise. Since the weather seal is made from an elastomeric material, it compresses upon closing of the closure panel and is maintained in this compressed state via the closure latch assembly holding the closure panel in its closed position.

As is well recognized, increasing the compressive clamping force applied to the weather seal results in improved noise reduction within the passenger compartment. However, holding the weather seal in a highly compressed condition tends to force the closure panel toward its open position such that this “opening” seal force is resisted by the pawl in its ratchet holding position and the ratchet in its striker capture position. Because the seal loads exerted on the latch mechanism are increased, the “release” force required to actuate the power-operated latch release mechanism for moving the pawl to its ratchet releasing position is also increased, thereby impacting the size and power requirements of the power release actuator. In addition, an audible sound, commonly referred to as “popoff” noise, is sometimes generated following actuation of the latch release mechanism and subsequent release of the latch mechanism due to engagement between the striker and the ratchet caused by release of the compressive seal loads as the ratchet is driven from its striker capture position toward its striker release position.

To address the compromise between the desire for higher seal loads and lower latch release forces, it is known to provide the closure latch assembly with an arrangement configured to coordinate the release of the seal loads with release of the latch mechanism. For example, European Publication No. EP1176273 disclosed a power-operated latch release mechanism configured to provide a progressive release of the ratchet associated with the latch mechanism in an effort to reduce the popoff noise. Alternatively, European Publication No. EP0978609 discloses an eccentric release mechanism used in association with the latch mechanism to reduce the seal loads prior to release of the ratchet. It is also known to employ a double pawl/double ratchet latch mechanism to reduce the latch release force required from the power release actuator.

It is also known to equip the closure latch assembly with a secondary or “safety” latch mechanism which only interacts with the primary latch mechanism in the event of a crash situation in order to prevent unintended release of the primary latch mechanism. Obviously, the inclusion of such additional mechanisms into the closure latch assembly, while providing a desirable feature, significantly impacts the complexity and packaging requirements.

While current closure latch assemblies of the type used in motor vehicle closure systems are sufficient to meet all regulatory requirements and provide enhanced comfort and convenience features, a need still exists to design and develop alternative closure latch assemblies and related power-operated mechanisms therein that advance the technology and further address and overcome at least some of the known shortcomings.

### SUMMARY

This section provides a general summary of various inventive concepts associated with the present disclosure. However, this section is not intended to be considered an exhaustive and comprehensive listing of all aspects, features and possible embodiments associated with the present disclosure.

It is an aspect of the present disclosure to provide a closure latch assembly for a motor vehicle closure system which is generally configured to provide a power latch release function having a “soft opening” feature.

It is a related aspect of the present disclosure to provide the closure latch assembly with a primary latch mechanism and a power-operated latch release mechanism which interact to provide the soft opening power latch release function.

It is a further related aspect of the present disclosure to provide the closure latch assembly with a secondary latch mechanism that is operably associated with the primary latch mechanism and the power-operated latch release mechanism to provide a safety latch function in the event of a vehicle crash situation.

It is yet another related aspect of the present disclosure to provide the closure latch assembly with a power actuation mechanism that is configured to coordinate actuation of the latch release mechanism and the safety latch mechanism to provide both the power latch release function and the safety latch function.

In one aspect, a closure latch assembly for a motor vehicle closure system is provided, including a primary latch mechanism, a latch release mechanism for selectively releasing the primary latch mechanism, a secondary latch mechanism for blocking the release of the primary latch mechanism during a crash event; and a power actuation mechanism operable to initially actuate the secondary latch mechanism to unblock the primary latch mechanism and actuate the latch release mechanism to release the primary latch mechanism.

According to another aspect, there is provided a closure latch assembly for a motor vehicle closure system for releasable engagement with a striker. The closure latch assembly includes a primary latch mechanism moveable between a striker capture position to releaseably retain the striker and a striker release position to release the striker, and a latch release mechanism for selectively releasing the primary latch mechanism. The latch release mechanism includes a pawl moveable between a ratchet holding position whereat the pawl engages the ratchet for holding the ratchet in its striker capture position over a first range of movement of the ratchet towards the striker release position, and a ratchet releasing position whereat the pawl is disengaged from the ratchet for permitting the ratchet to be driven toward its striker release position over a second range of movement. During the first range of movement the pawl inhibits movement of the ratchet to below a velocity threshold, and during the second range of movement the ratchet is permitted to move above the velocity threshold. A power actuation mechanism operable to actuate the pawl, either directly or indirectly, to release the primary latch mechanism is also provided.

In another aspect, a method of operating a closure latch assembly is provided. The method includes providing the closure latch assembly having a primary latch mechanism, a latch release mechanism for selectively releasing the primary latch mechanism, a secondary latch mechanism for blocking the release of the primary latch mechanism during a crash event, and a power actuation mechanism operably coupled to the secondary latch mechanism and the latch release mechanism.

The method may further include actuating the power actuation mechanism in a first direction and, in response thereto, actuating the secondary latch mechanism in a first direction and unblocking the primary latch mechanism. The method may further include, in response to actuating the power actuation mechanism in the first direction, actuating the latch release mechanism.

The method may include opening the primary latch mechanism at a first speed during a first period of actuation. The method may further include opening the primary latch mechanism at a second speed higher than the first speed during a second period of actuation.

The method may include configuring the power actuation mechanism to include an actuation member engaged with a release lever of the latch release mechanism and a crash pawl of the secondary latch mechanism, such that the release lever is engaged with the pop-up lever, wherein movement of the actuation member causes movement of release lever and associated movement of the pop-up lever, and movement of the actuation member further causes movement of the crash pawl and the secondary latch mechanism.

In accordance with another aspect there is provided a closure latch assembly for a motor vehicle closure system, including a primary latch mechanism, a latch release mechanism for selectively releasing the primary latch mechanism, and a power actuation mechanism operable to opening the primary latch mechanism at a first speed during a first period of actuation and opening the primary latch mechanism at a second speed higher than the first speed during a second period of actuation.

In accordance with another aspect there is provided a method for operating a closure latch assembly, the method including the steps of providing a closure latch assembly having a primary latch mechanism, a latch release mechanism for selectively releasing the primary latch mechanism, and a power actuation mechanism operably coupled to the latch release mechanism, actuating the power actuation mechanism in a first direction and, in response thereto, in response to actuating the power actuation mechanism in the first direction, actuating the latch release mechanism, opening the primary latch mechanism at a first speed during a first period of actuation, and opening the primary latch mechanism at a second speed higher than the first speed during a second period of actuation.

Further areas of applicability will become apparent from the following detailed description when considered in conjunction with the accompanying drawings. As noted, the description and specific examples set forth in this summary are intended only to identify inventive concepts and features associated with the present disclosure and are not intended to limit the scope of the present disclosure.

### DRAWINGS

One or more non-limiting embodiments of the present disclosure are illustrated in the following drawings, in which:

FIG. 1 is a partial isometric view of a motor vehicle having a closure panel equipped with a closure latch assembly constructed in accordance with the teachings of the present disclosure;

FIG. 2 is a plan view of a strength module associated with the closure latch assembly of the present disclosure and which is shown equipped with a primary latch mechanism, a latch release mechanism operably associated with the primary latch mechanism, a power actuation mechanism operable to actuate the latch release mechanism to provide a power latch release function, and a secondary latch mechanism controlled by the power actuation mechanism to provide a safety latch function;

FIG. 3 is an enlarged partial view taken from FIG. 2 and which illustrates a soft opening cam arrangement between a latch plate of the strength module and the primary latch mechanism;

FIG. 4 illustrates the closure latch assembly in a “Latched” mode with the primary latch mechanism operating in a striker captured state, the latch release mechanism operating in a pawl engaged state, the secondary latch mechanism operating in a ratchet blocked state, and the power actuation mechanism operating in a non-actuated state;

FIGS. 5 through 11 are a first series of sequential views illustrating the closure latch assembly being shifted from its Latched mode into an “Unlatched” mode in response to the power actuator mechanism being shifted from its non-actuated state into an actuated state for causing the latch release mechanism to shift from its pawl engaged state into a pawl disengaged state for shifting the primary latch mechanism from its striker captured state into a striker released state and for causing the secondary latch mechanism to shift from its ratchet blocked state into a ratchet unblocked state;

FIGS. 12 and 13 are a second series of sequential views illustrating a resetting operation for shifting the closure latch assembly from its Unlatched mode in a “Reset” mode;

FIGS. 14 through 17 are a third series of sequential views illustrating a closing operation for shifting the closure latch assembly from its Reset mode back into its Latched mode;

FIG. 18 illustrates a method of operating the closure latch assembly;

FIGS. 19 and 20 illustrate another aspect of a closure latch assembly in a home position, including an emergency lever, a release lever, a pop-up lever, and a cinch mechanism, where the closure latch assembly is configured to provide soft opening and cinching functionality;

FIGS. 21 and 22 are perspective view of the closure latch assembly of FIG. 19, illustrating both the front and rear views thereof;

FIGS. 23-30 illustrate sequential actuation of the closure latch assembly to open a ratchet, where the release lever is rotated, the crash pawl rotates, the pop-up lever rotates, the emergency lever rotates, and a pop-up pawl releases the ratchet;

FIGS. 31-35 sequentially illustrate the ratchet being closed, and the cinch mechanism being actuated to cinch the ratchet fully closed;

FIG. 36 illustrates the cinch mechanism returning to the home position and the latch assembly being closed;

FIG. 37 illustrates an emergency actuation, where the cinch mechanism is still in the cinched position, holding the pop-up lever, where the release lever contacts the emergency lever to open the emergency lever and force the crash pawl open and the pop-up pawl out of engagement with the ratchet to release the ratchet;

FIG. 38 is an isometric view illustrating the crash pawl and the ratchet;

FIG. 39 is an isometric view illustrating the release lever;

FIGS. 40 and 41 are isometric views of the pop-up lever;

FIG. 42 is an isometric view of the release lever; and

FIG. 43 is an isometric view of the release lever and the emergency lever.

Corresponding reference numerals are used to indicate corresponding components throughout the several views of the drawings.

### DETAILED DESCRIPTION

Example embodiments of a closure latch assembly constructed according to the teachings of the present disclosure will now be described more fully with reference to the accompanying drawings. To this end, the example embodiments are provided so that this disclosure will be thorough, and will fully convey its intended scope to those who are skilled in the art. Accordingly, numerous specific details are set forth such as examples of specific components, devices, and methods, to provide a thorough understanding of embodiments of the present disclosure. However, it will be apparent to those skilled in the art that specific details need not be employed, that example embodiments may be embodied in many different forms, and that neither should be construed to limit the scope of the present disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIGS. is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In the following detailed description, the expression “closure latch assembly” will be used to generally indicate any power-operated latch device adapted for use with a vehicle closure panel to provide a power latch release function in combination with a soft opening feature. Additionally, the expression “closure panel” will be used to indicate any element moveable between an open position and at least one closed position, respectively opening and closing an access to an inner compartment of a motor vehicle and therefore includes, without limitations, decklids, tailgates, liftgates, bonnet lids, and sunroofs in addition to the sliding or pivoting side passenger doors of a motor vehicle to which the following description will make explicit reference, purely by way of example.

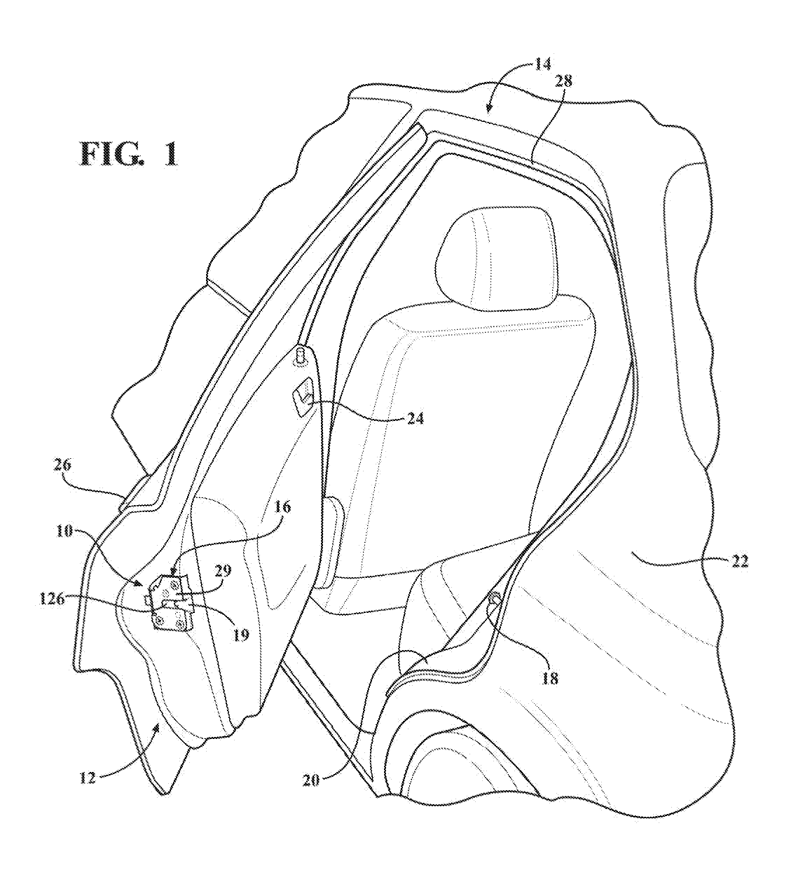

Referring initially to FIG. 1 of the drawings, a motor vehicle 10 is shown to include a vehicle body 12 defining an opening 14 to an interior passenger compartment. A closure panel 16 is pivotably mounted to vehicle body 12 for movement between an open position (shown) and a fully-closed position to respectively open and close opening 14. A closure latch assembly 18 is rigidly secured to closure panel 16 adjacent to an edge portion 16A thereof and is releaseably engageable with a striker 20 that is fixedly secured to a recessed edge portion 14A of opening 14. As will be detailed, closure latch assembly 18 is operable to engage striker 20 and hold closure panel 16 into its fully-closed position. An outside handle 22 and an inside handle 24 are provided for actuating closure latch assembly 18 to release striker 20 and permit subsequent movement of closure panel 16 to its open position. An optional lock knob 26 is shown which provides a visual indication of the locked state of closure latch assembly 18 and which may also be operable to mechanically change the locked state of closure latch assembly 18. A weather seal 28 is shown mounted on edge portion 14A of opening 14 in vehicle body 12 and is adapted to be resiliently compressed upon engagement with a mating sealing surface of closure panel 16 when closure panel 16 is held by closure latch assembly 18 in its fully-closed position so as to provide a sealed interface therebetween. This sealed interface is configured to prevent entry of rain and dirt into the passenger compartment while also minimizing audible wind and road noise. For purpose of clarity and functional association with motor vehicle 10, the closure panel is hereinafter referred to as passenger door 16.

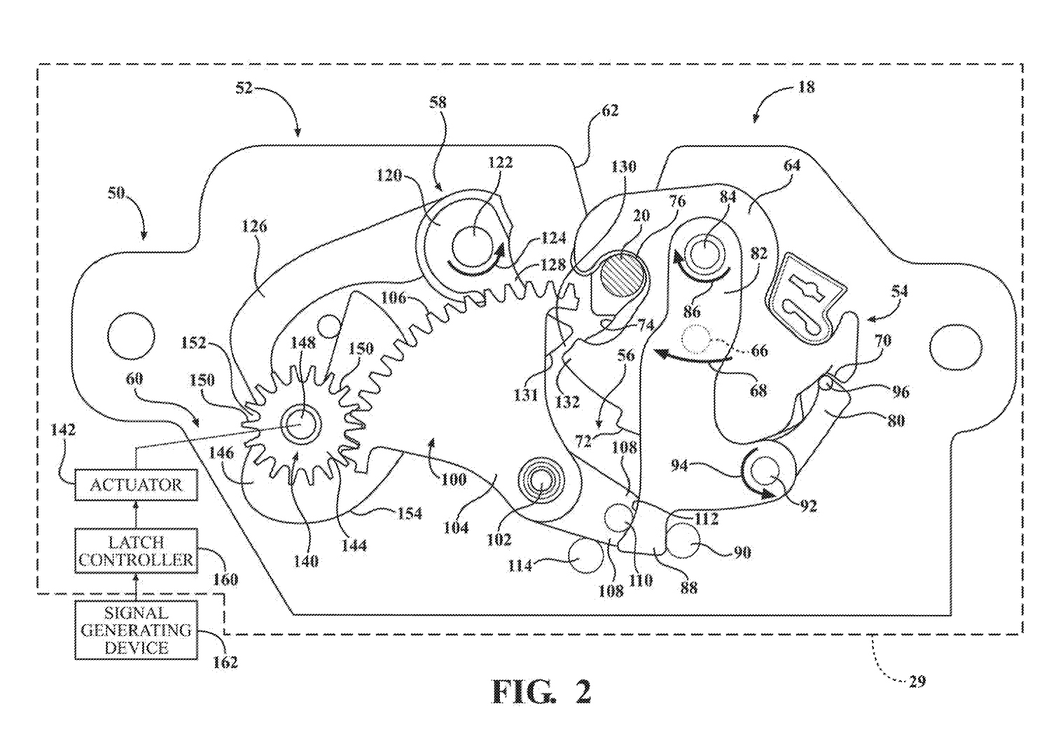

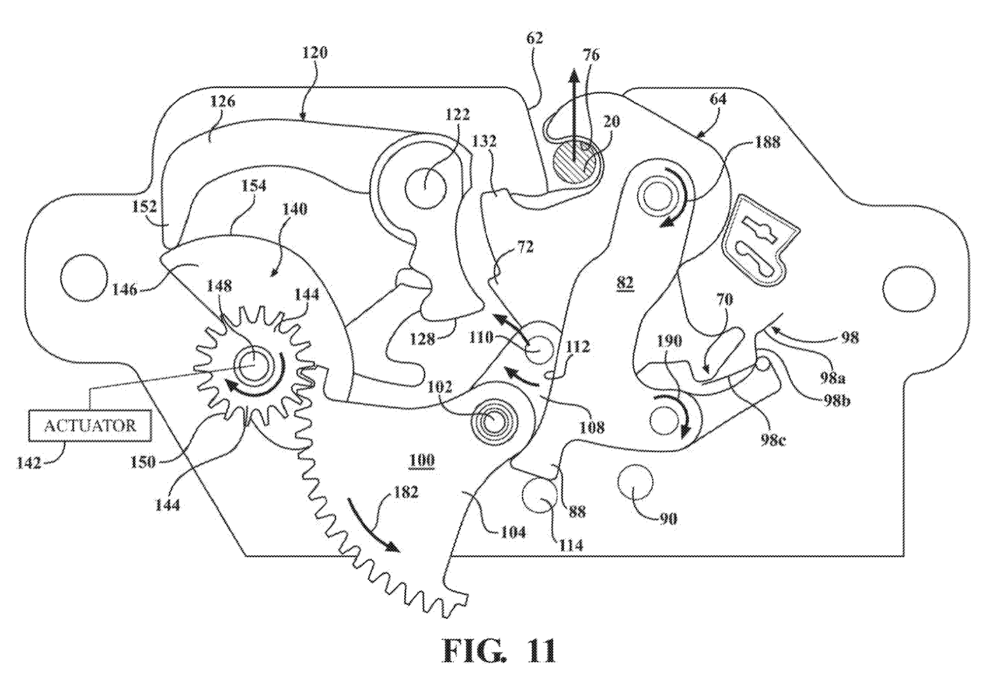

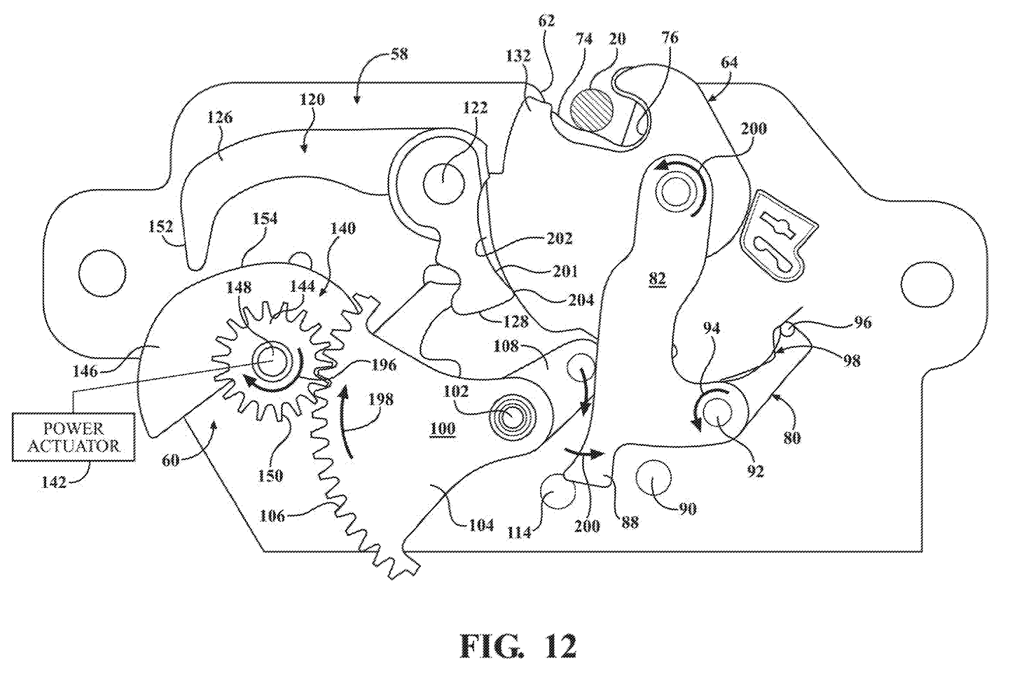

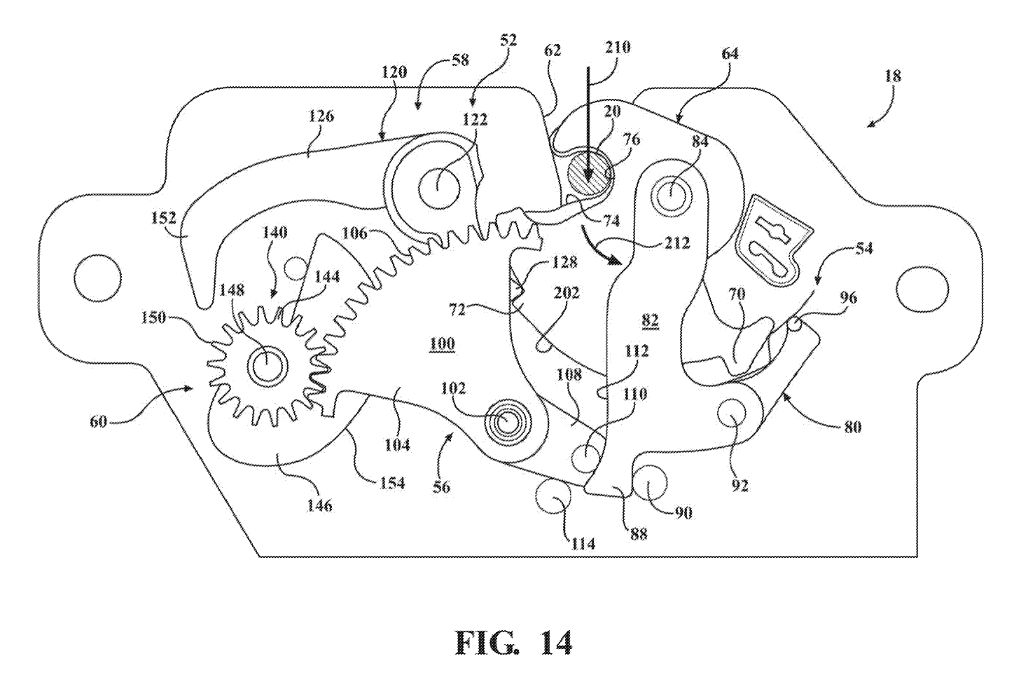

Referring initially to FIG. 2, closure latch assembly 18 is shown to generally include a strength module 50 having a latch plate 52, a primary latch mechanism 54, a latch release mechanism 56, a secondary latch mechanism 58, and a power actuation mechanism 60. Latch plate 52 is a structural component and is configured to include a fishmouth entry channel 62 through which striker 20 moves in response to movement of door 16 between its fully-closed and open positions. Primary latch mechanism 54 includes a ratchet 64 mounted to latch plate 52 for rotation about a ratchet post 66 between a striker release position (FIG. 12), a secondary striker capture position (FIG. 14) and a primary striker capture position (FIG. 2). A ratchet biasing member, schematically indicated by arrow 68, acts to normally bias ratchet 64 toward its striker release position. Ratchet 64 is formed to include a primary latch shoulder 70, a secondary latch shoulder 72, and a striker guide channel 74 terminating in a striker capture seat 76. Ratchet 64 is located in its striker release position when door 16 is open, is located in its secondary striker capture position when door 16 is held in a partially-closed position, and is located in its primary striker capture position when door 16 is held in its fully-closed position and weather seal 28 is fully compressed.

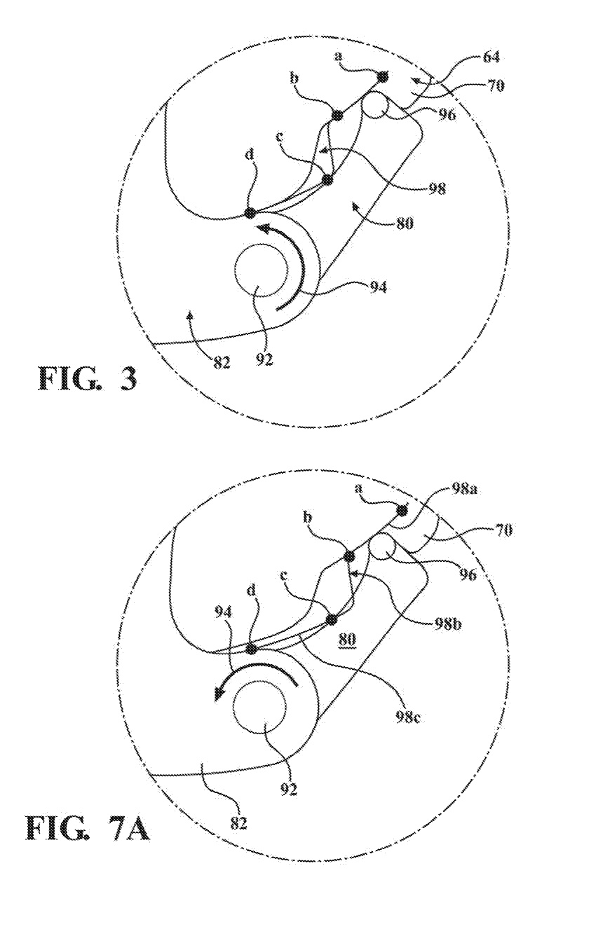

Primary latch mechanism 54 also includes a first or “pop-up” pawl 80 and a pop-up lever 82. Pop-up lever 82 is mounted to latch plate 52 (or another structural component of the latch housing) for rotation about a lever post 84 between a blocking position (FIG. 2) and an unblocking position (FIG. 11). A pop-up lever biasing member, schematically indicated by arrow 86, normally biases pop-up lever 82 toward its unblocking position. Note from FIG. 2 that a stop lug portion 88 of pop-up lever 82 engages a stop post 90 extending from latch plate 52 when pop-up lever 82 is located in its blocking position. Pop-up pawl 80 is mounted to pop-up lever 82 for pivotal movement about a pawl post 92 between a ratchet holding position (FIG. 3) and a ratchet releasing position (FIG. 11). A pop-up pawl biasing member, schematically indicated by arrow 94, normally biases pop-up pawl 80 towards its ratchet holding position. A pawl lug 96 formed on pop-up pawl 80 engages primary latch shoulder 70 on ratchet 64 when pawl 80 is located in its ratchet holding position for holding ratchet 64 in its primary striker capture position.

FIG. 3 is an enlarged portion of FIG. 2 and illustrates a control cam arrangement established between pawl lug 96 on pop-up pawl 80 and a profiled control cam surface 98 formed on latch plate 52. Sliding movement of pawl lug 96 against control cam surface 98 from point “A” to point “D” in response to movement of pop-up lever 82 from its blocking position into its unblocking position causes pop-up pawl 80 to move from its ratchet holding position into its ratchet releasing position in conjunction with rotational movement of ratchet 64 in a releasing (i.e. clockwise) direction from its primary striker capture position toward its striker release position. This coordinated movement of pop-up pawl 80 and ratchet 64 provides a “soft opening” feature which functions to progressively release the compressive clamping forces applied by weather seal 28 on latch mechanism 54 to prevent generation of undesirable pop-off noise when latch mechanism 54 is released.

With continued reference to FIG. 2, latch release mechanism 56 is shown, in this non-limiting embodiment, to include a release lever 100 mounted to latch plate 52 for rotation about a release lever post 102 between a home position (FIG. 2) and an actuated position (FIG. 11). Release lever 100 includes a gear segment 104 having gear teeth 106 and a drive cam segment 108 having a drive cam lug 110. Note from FIG. 2 that drive cam lug 110 engages a cam edge surface 112 formed on stop lug portion 88 of pop-up lever 82 when release lever 100 is located in its home position for holding pop-up lever 82 in its blocking position. A stop lug 114 on latch plate 52 engages drive cam segment 108 to positively locate release lever 100 in its home position.

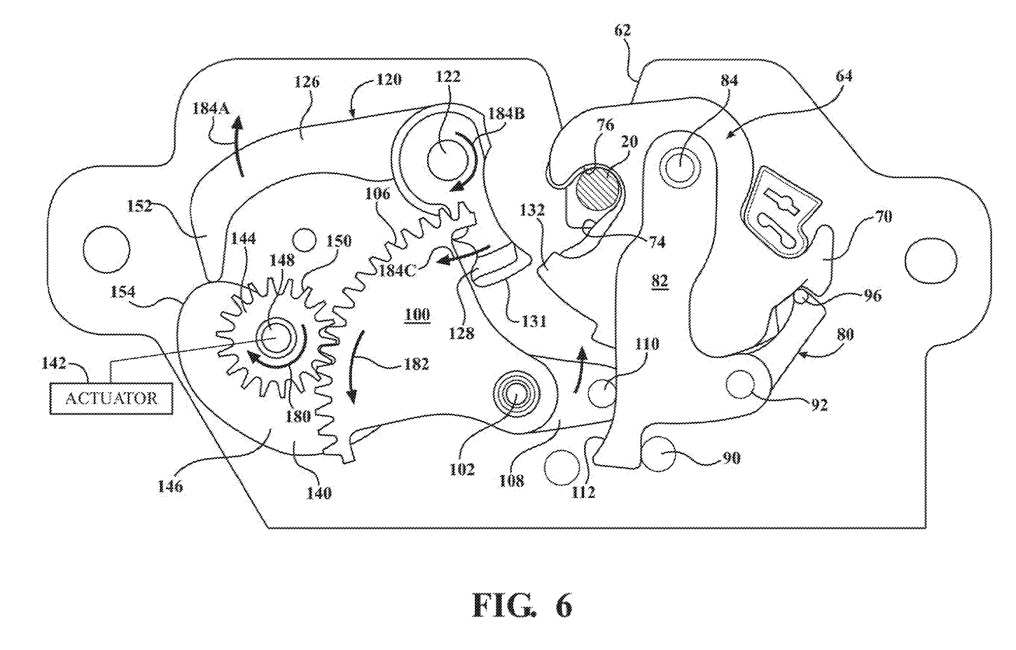

Secondary latch mechanism 58, also referred to as safety latch mechanism, is shown, in this non-limiting embodiment, to include a second or “crash” pawl 120 mounted to latch plate 52 for rotation about a crash pawl post 122 between a ratchet blocked position (FIG. 2) and a ratchet unblocked position (FIG. 6). A crash pawl biasing member, schematically indicated by arrow 124, normally biases crash pawl 120 toward its ratchet blocked position. Crash pawl 120 is configured to include an actuation arm segment 126 and a blocking arm segment 128. As shown in FIG. 2, a small gap 130 is provided between a blocking surface 131 of blocking arm segment 128 on crash pawl 120 and a safety latch shoulder 132 formed on ratchet 64 when crash pawl 120 is located in its ratchet blocked position and ratchet 64 is held in its primary striker capture position. This arrangement is provided to assure that ratchet 64 is not unintentionally released and permitted to move to its striker release position as a result of a crash event. As will be detailed, movement of crash pawl 120 from its ratchet blocked position to its ratchet unblocked position causes blocking arm segment 128 to move out of alignment with safety latch shoulder 132 on ratchet 64, thereby allowing ratchet 64 to move to its striker release position in response to an intentional release of latch mechanism 54. As will also be detailed, the controlled movement of the pawl 80 to control the movement of the ratchet 64 towards the striker release position, as opposed to a sudden releasing movement of the crash pawl 120, will provide for the advantages discussed herein.

With continued reference to FIG. 2, power actuation mechanism 60 is shown, in this non-limiting embodiment, to include an actuation member 140 and a power actuator 142. Power actuator 142, while only shown schematically, includes an electric motor and reduction gearset configured to control rotation of actuation member 140. Actuation member 140 includes a power release gear segment 144 and a crash pawl cam segment 146. Actuation member 140 is mounted to latch plate 52 for rotation about an actuation post 148 through a range of positions including a first or “start” position, a second or “intermediate” position, and a third or “stop” position. Actuation member 140 can be rotated in both of a first or “actuation” direction (i.e. clockwise) from its start position to its stop position and in a second or “resetting” direction (i.e. counterclockwise) from its stop position back to its start position. Gear teeth 150 on power release gear segment 144 are in constant mesh with teeth 106 on gear segment 104 of release lever 100. In addition, an end portion 152 of arm segment 126 of crash pawl 120 is configured to engage a contoured cam edge surface 154 formed on crash pawl cam segment 146 of actuation member 140.

In operation, rotation of actuation member 140 in the first direction from its start position (FIG. 2) to its stop position (FIG. 11) causes release lever 100 to rotate about release lever post 102 from its home position (FIG. 2) to its actuated position (FIG. 11) which, in turn, permits pop-up lever biasing member 86 to move pop-up lever 82 from its blocking position (FIG. 2) to its unblocking position (FIG. 11). As noted, such movement of pop-up lever 82 causes pawl lug 96 (while maintained in engagement with primary latch shoulder 70 on ratchet 64) to ride along control cam surface 98 on latch plate 52 from point A to point D which, in turn, functions to cause pop-up pawl 80 to move from its ratchet holding position into its ratchet releasing position. During its range of movement between point A to point C in which the pop-up pawl 80 is maintained in its ratchet holding position, the pawl lug 96 (while maintained in engagement with primary latch shoulder 70 on ratchet 64) acts to resist the rotation of the ratchet 64 towards its striker release position, as either caused by the seal loading acting on the ratchet 64 and/or due to the bias acting on the ratchet 64, to a first velocity or speed that is below a threshold that would eliminate or minimize the “pop-up noise”. Point C may correspond to a point at which the releasing of the seal loading will not cause or significantly cause the pop-up noise. After point C, at which the pop-up pawl 80 is caused to move from its ratchet holding position into its ratchet releasing position whereby ratchet 64 is then free (e.g. unrestricted) to move to its striker release position at a velocity speed that is greater or above the speed of movement during the pop-up pawl 80 engagement with the ratchet 64 during its ratchet holding position over the first range of motion. During the first range of movement, the speed of the ratchet 64 is thus controlled by the controlled movement of the pop-up pawl 80 to slowly (e.g. compared to an uncontrolled ratchet releasing rotational speed) release the seal loading to reduce or eliminate the pop-up noise.

In coordination with this “power latch release” operation, rotation of actuation member 140 in the first direction from its start position (FIG. 2) to its intermediate position (FIG. 6) also causes crash pawl 120 to move from its ratchet blocked position (FIG. 2) into its ratchet unblocked position (FIG. 6) in response to engagement of end portion 152 on crash pawl arm segment 126 with cam edge surface 154 on crash pawl cam segment 146. As noted, such rotation of crash pawl 120 to its ratchet unblocked position results in movement of blocking surface 131 on blocking arm segment 128 to a position displaced from alignment with safety latch shoulder 132 on ratchet 64. The kinematics are designed such that crash pawl 120 moves to its ratchet unblocked position via actuation of secondary latch mechanism 58 prior to movement of pop-up pawl 80 to its ratchet releasing position via actuation of latch release mechanism 56 so as to permit ratchet 64 to subsequently move without obstruction to its striker release position.

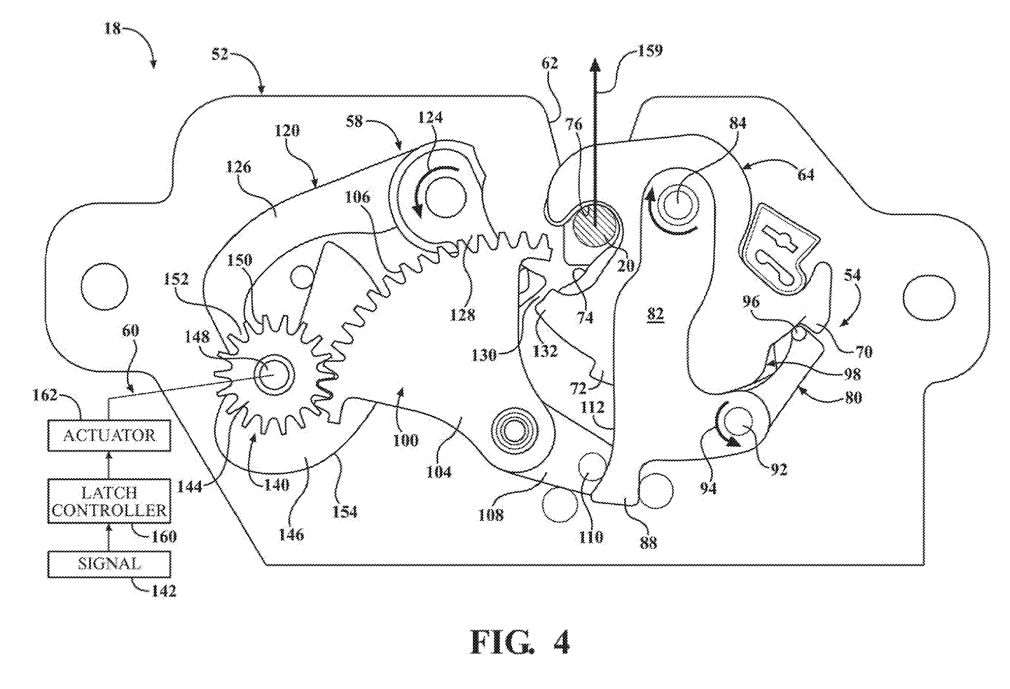

Referring now to FIG. 4, closure latch assembly 18 is shown in a “Latched” mode with primary latch mechanism 54 operating in a striker captured state, latch release mechanism 56 operating in a pawl engaged state, secondary latch mechanism 58 operating in a ratchet blocked state, and power actuation mechanism 60 operating in a non-actuated state. The Latched mode of closure latch assembly 18 is established when door 16 is located in its fully-closed position such that striker 20 is retained within striker capture seat 76 of ratchet 64. To establish these various states of operation, ratchet 64 is held in its primary striker capture position via pop-up pawl 80 being located in its ratchet holding position with pop-up lever 82 located in its blocking position, actuation member 140 is located in its start position, release lever 100 is located in its home position, and crash pawl 120 is located in its ratchet blocking position. Note that arrow 159 indicates the seal loads exerted by weather seal 28 on striker 20 when door 16 is held in its fully-closed position. These seal loads 159 cause striker 20 to act on ratchet 64 so as to attempt to drive ratchet 64 in an opening (i.e. clockwise) direction toward its striker release position. As shown in FIG. 4, there is no contact between crash pawl 120 and ratchet 64, which is illustrated by gap 130. The crash pawl 120 is positioned to block movement of the ratchet 64 in the event of a crash, due to the actuation member 140 not being actuated.

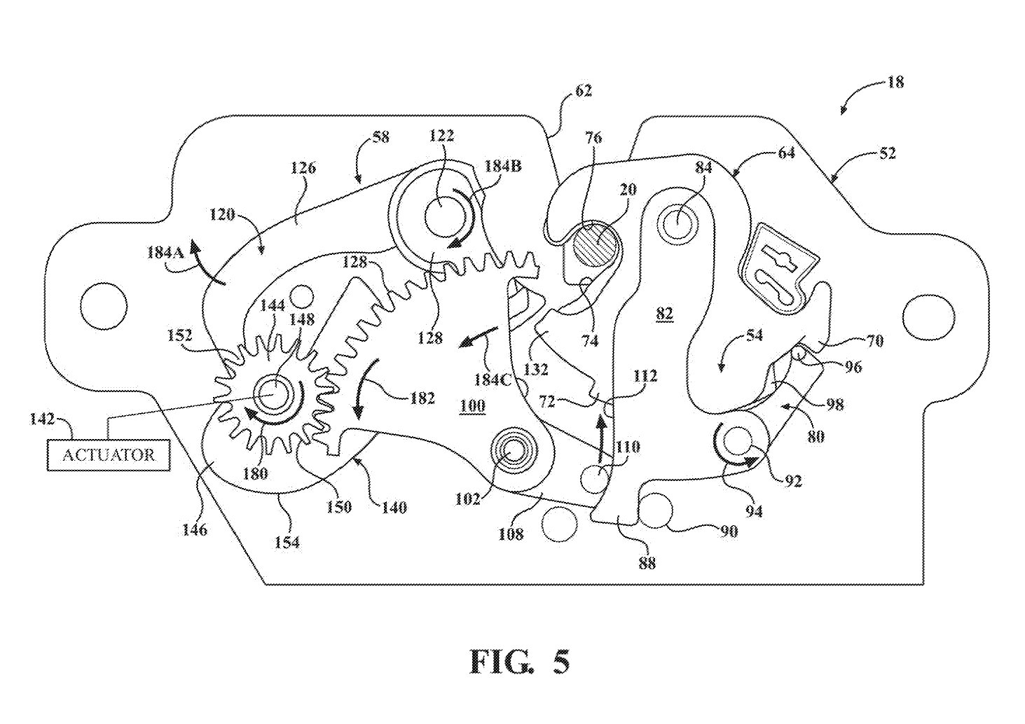

FIGS. 5 through 11 are a first series of sequential views, similar to FIG. 4, but showing actuation of power actuation mechanism 60 and the subsequent movement of the components associated with latch release mechanism 56, primary latch mechanism 54, and secondary latch mechanism 58 for shifting closure latch assembly 18 from its Latched mode into an “Unlatched” mode in response to a control signal received by a latch controller 160 (FIGS. 2 and 4), for example provided internal to latch housing 29, requesting initiation of the power latch release operation and associated movement of the actuation member 140. As is well known, latch controller 160 receives a power release signal from a signal generating device 162 which may include, for example and without limitation, a key fob and/or a handle-mounted latch release switch.

FIG. 5 illustrates the beginning of a release operation relative to the Latch state shown in FIG. 4. FIG. 5 illustrates power actuator 142 initiating rotation of actuation member 140 in the first (i.e. clockwise) direction (arrow 180) out of its start position which causes power release gear segment 144 to begin rotating release lever 100 about release lever post 102 from its home position toward its actuated position (FIG. 11), as schematically indicated by arrow 182. The contoured profile of cam edge surface 112 on stop lug portion 88 of pop-up lever 82 is configured (arc k-m) such that continued engagement with drive cam lug 110 maintains pop-up lever 82 in its blocking position so as to maintain pawl lug 96 on pop-up pawl 80 in latched engagement with primary latch shoulder 70 on ratchet 64. That said, pop-up pawl 80 is maintained by pawl biasing member 94 in its ratchet holding position so as to maintain ratchet 64 in its primary striker capture position.

Also, during such continued engagement with the arcuate portion of cam edge surface 112 (i.e. arc k-m), the ratchet 64 is maintained in an overtravel position whereby gap 130 is maintained, despite a movement of drive cam segment 108 engaging cam edge surface 112 between this arcuate portion (arc k-m). When drive cam segment 108 reaches point m, the crash pawl 120 will have transitioned to its ratchet unblocked position, ensuring the subsequently controlled (lower velocity) release of the ratchet 64 will not be interference with by the crash pawl 120.

FIG. 5 also illustrates that initial rotation of actuation member 140 in the first direction out of its start position causes cam edge surface 154 on crash pawl cam segment 146 to forcibly drive crash pawl 120 to rotate about post 122 from its ratchet blocked position toward its ratchet unblocked position, as indicated by arrows 184A-C. As shown in FIG. 5 relative to FIG. 4, the crash pawl cam segment 146 is contact with end portion 152 of crash pawl 120 in FIG. 5, where it was not in contact in FIG. 4.

FIG. 6 is similar to FIG. 5 but now shows continued rotation of actuation member 140 in the first direction into its intermediate position which results in crash pawl 120 being located in its ratchet unblocked position while continued movement of release lever 100 towards its actuated position (arrow 182) maintains engagement of drive cam lug 110 of release lever 100 with cam surface 112 of pop-up lever 82, thereby continuing to hold pop-up lever 82 in its blocking position. Thus, secondary latch mechanism 58 has been shifted from its ratchet blocked state into its ratchet unblocked state. In this state, the ratchet 64 would be free to rotate past the crash pawl. However, in this state, pop-up pawl 80 remains engaged with primary latch shoulder 70 of ratchet 64, because lug 110 remains in contact with surface 112 to block rotation of pup-up lever 82

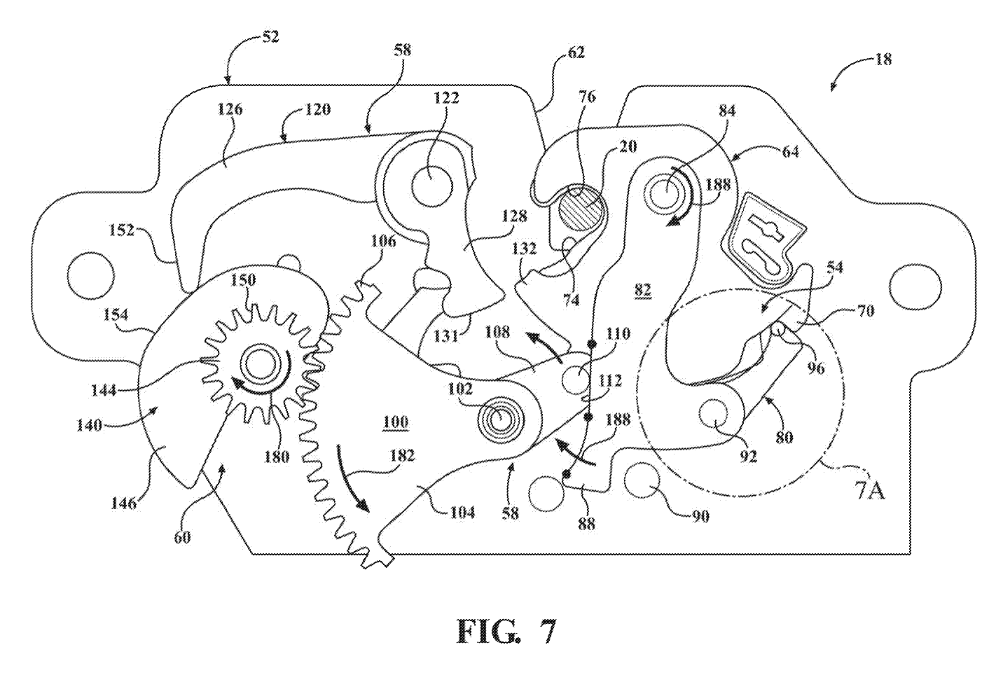

FIGS. 7 and 7A are similar to FIG. 6, but now show that continued rotation of actuation member 140 in the first direction has resulted in crash pawl 120 being held in its ratchet unblocked position with blocking surface 131 on blocking arm segment 128 shown displaced from alignment with safety latch shoulder 132 on ratchet 64. In addition, release lever 100 has now been rotated to an intermediate position whereat the interaction between drive cam lug 110 and cam surface 112 (see arc m-e) now permits initial rotation of pop-up lever 82 from its blocking position toward its unblocking position, as schematically indicated by arrow 188. Illustratively, arc m-e is defined as a non-arcuate surface of cam surface 112, for example it may be linear. As a result, the non-arcuate, or illustratively linear cam surface 112 of FIG. 5 results in a controlled pawl 80 movement relative to the movement of the drive cam segment 108.

Illustratively, the cam surface 112 over its surface portion defined by arc m-e may be arcuate, or a combination of arcuate and non-arcuate, depending on the desired speed control profile to be imparted to the pawl 80. The resistance supplied by the pawl 80 on the ratchet 64 is provided illustratively by the gear ratios provided between the gear teeth 150 on power release gear segment 144 meshing with teeth 106 on gear segment 104 of release lever 100, and/or resistance provided by the actuator 142. Other manners of providing a resistance, distinct or in combination to the manner described herein above, to the motion of the pawl 80 are contemplated, for example as provided by a spring bias acting on release lever 100. As described above, the bias on the pop-up lever 82 is such that the pop-up lever 82 is urged toward opening to allow the striker 20 be released. Accordingly, it is the location and movement of the lug 110 along the release lever 82 and its cam surface 112 that allows the pop-up lever 82 to ultimately rotate in the direction of its bias.

Note from FIG. 7A that such initial rotation of pop-up lever 82 about lever post 84 also causes concurrent movement of pop-up pawl 80 such that pawl lug 96 has moved from point A toward point B along a first segment 98A of control cam surface 98 while continuing to engage primary latch shoulder 70 on ratchet 64. As such, ratchet 64, via its ratchet biasing member 68, is permitted to rotate slightly about ratchet post 66 in the releasing direction from its primary striker capture position, thereby initiating an unloading or “release” of the seal loads generated by compressed weather seal 28 as part of a “soft opening” function. The position of the pawl lug 96 along cam surface 98 in FIG. 7A may be compared to the position shown in FIG. 3 to illustrate the slight movement of both the pawl lug 96 and the primary latch shoulder 70 of the ratchet 64.

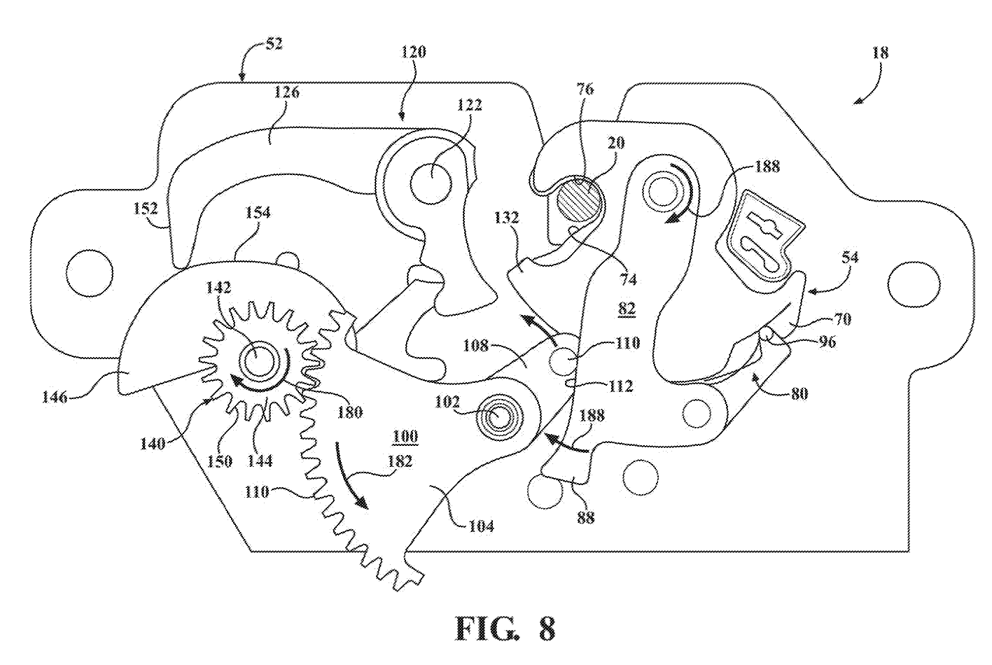

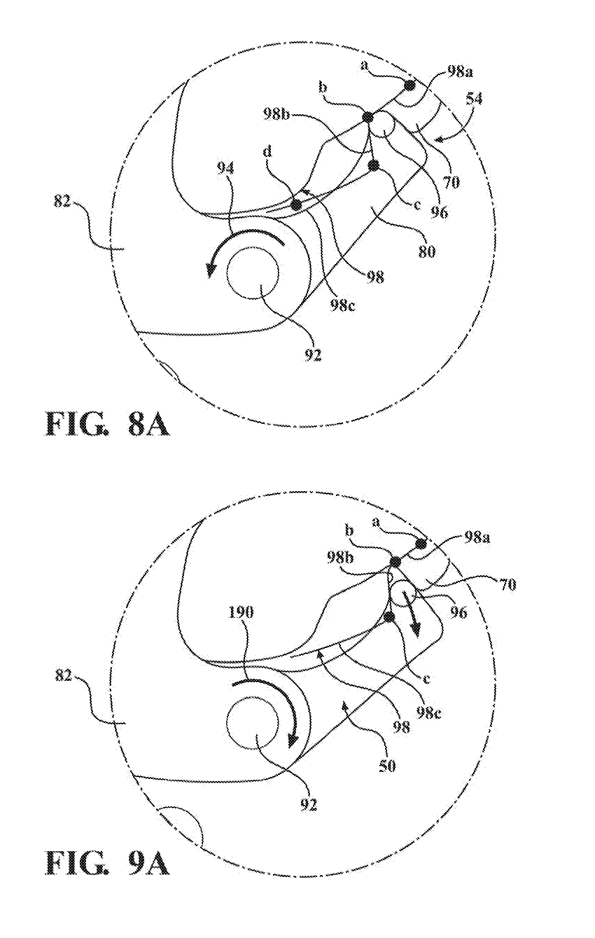

FIGS. 8 and 8A are similar to FIGS. 7 and 7A, respectively, but now show that continued rotation of actuation member 140 in the first direction (arrow 180) towards its stop position results in continued rotation of release lever 100 (arrow 182) towards its actuated position which, in turn, permits continued rotation of pop-up lever 82 (arrow 188) toward its unblocking position. As shown in FIG. 8 relative to FIG. 7, the lug 110 has traveled further along cam surface 112 in accordance with the continued rotation of release lever 100, and the pop-up lever 82, due to its bias, accordingly rotates and maintains contact between the lug 110 and cam surface 112.

As further shown in FIG. 8, the continued rotation of actuation member 140 has caused continued rotation of the crash pawl 120 due to the engagement between cam segment 146 and end portion 152, providing even larger clearance between the crash pawl 120 and the ratchet 64.

Note from FIG. 8A that such continued rotation of pop-up lever 82 and pop-up pawl 80 has caused pawl drive lug 96 to slide along segment 98A of control cam surface 98 to point B while maintaining engagement with primary latch shoulder 70 on ratchet 64. That said, pop-up pawl 80 remains in its ratchet holding position while ratchet 64 is permitted to slightly further rotate in the releasing direction, thereby continuing to unload the seal loads generated by compressed weather seal 28 and which are exerted by striker 20 on ratchet 64. While the pop-up lever 82 and pawl 80 and ratchet have been allowed to rotate slightly, the ratchet 64 remains blocked from releasing due to the engagement between the lug 96 and the primary latch shoulder 70. While the lug 96 is at point B, at this point, continued rotation of the pop-up lever will soon drag the lug 96 toward point C and begin disengagement between the lug 96 and the primary latch shoulder 70.

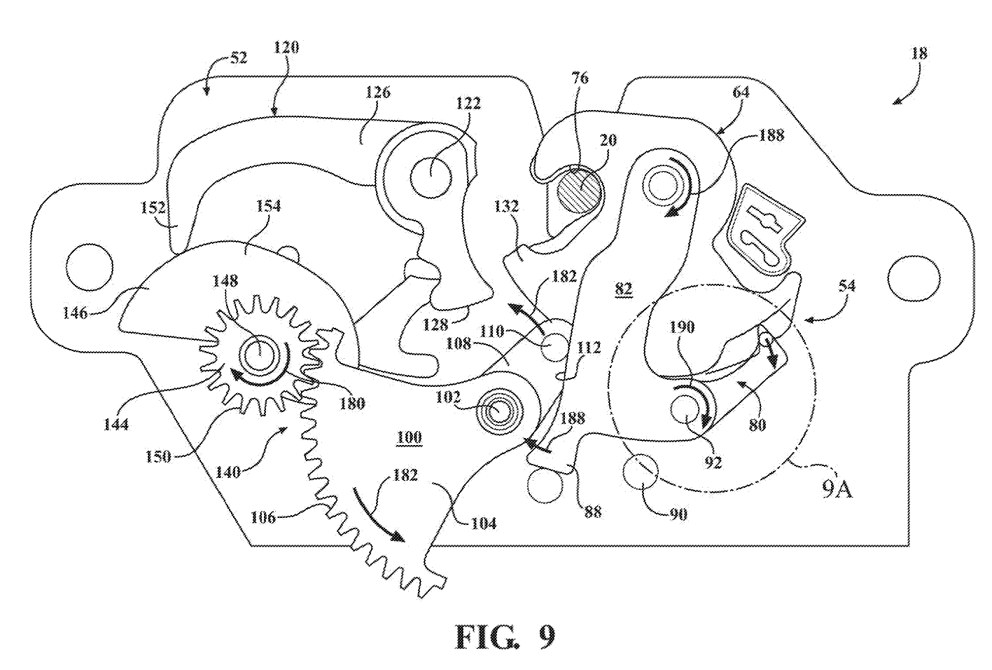

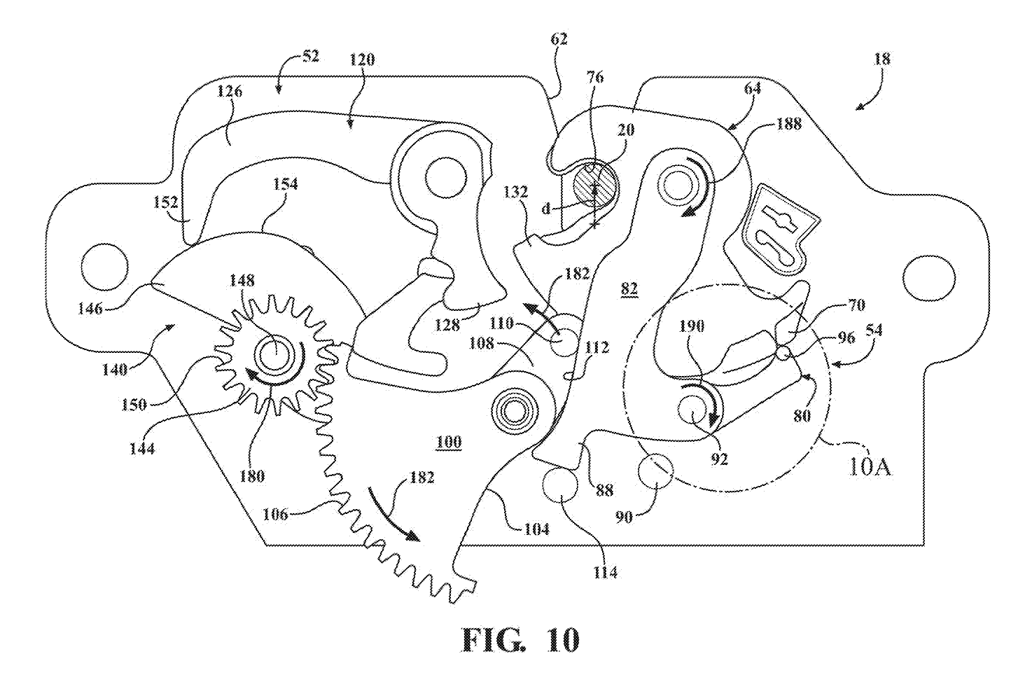

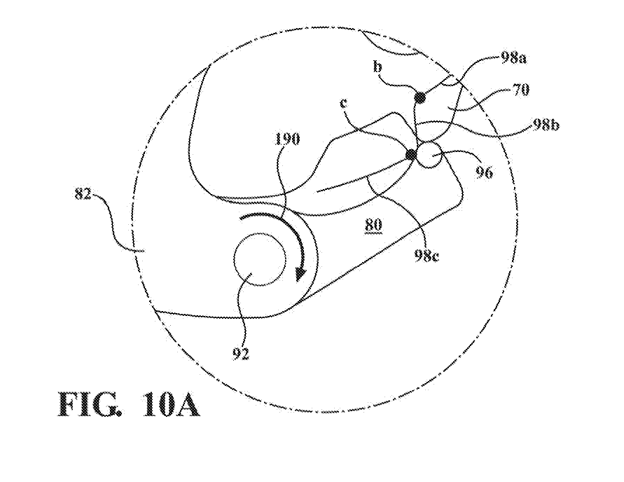

FIGS. 9 and 9A and FIGS. 10 and 10A illustrate that continued rotation of actuation member 140 in the first direction (arrow 180) towards its stop position has caused continued movement of release lever 100 (arrow 182) towards its actuated position. Such continued rotation of release lever 100 permits continued rotation of pop-lever 82 (arrow 188) sufficient to cause pawl lug 96 on pop-up pawl 80 to move from point B to point C on a second cam segment 98B of control cam surface 98, which functions to pivot pop-off pawl 80 from its ratchet holding position into its ratchet releasing position, in opposition to the biasing exerted thereon by pawl biasing member 94, as indicated schematically by arrow 190. At this point, the seal loads associated with weather seal 28 have been adequately released to avoid an audible pop-off noise upon subsequent release of striker 20 from ratchet 64.

FIG. 9A illustrates the pawl lug 96 at an intermediate position between points B and C, while FIG. 10A illustrates the pawl lug 96 at point C. The pop-up pawl 80 is permitted to pivot or rotate relative to the pop-up lever 82, allowing the pawl lug 96 to slide outward from point B to point C as the pop-up lever rotates slightly in response to the lug 110 sliding further along cam surface 112.

At the position illustrated in FIGS. 10 and 10A, with the pawl lug 96 at point C, the primary latch shoulder 70 is positioned at a “tipping point” wherein the ratchet 64 may be permitted to be released, because the primary latch shoulder 70 will not be blocked by the pawl 96. FIG. 10 illustrates the center of the striker 20 having been allowed to move a distance D under controlled motion of the pop-up lever 82 acting on ratchet 64 as compared to the center of the striker 20 as shown in FIG. 5. Therefore, during travel of the striker 20 over distance D, the striker velocity is controlled and pop-up noise may be reduced as a result for example.

With reference to FIG. 11, it is shown that the ratchet 64 has been released, such that the ratchet 64 has rotated a substantial degree relative to FIG. 10, while pop-up lever 82 and release lever 100 have shifted only slightly relative to FIG. 10. The ratchet 64 is permitted to rotate toward its striker release position because the crash pawl 120 is not blocking it, and the pop-up pawl 80 is not blocking it.

FIG. 11 also illustrates actuation member 140 rotated to its stop position such that release lever 100 is now located in its actuated position, pop-up lever 82 is now located in its unblocking position, pop-up pawl 80 is now located in its ratchet releasing position, and crash pawl 120 is maintained in its ratchet unblocked position, whereby the Unlatched mode for closure latch assembly 18 is established. Specifically, primary latch mechanism 54 is shown in its striker released state, latch release mechanism 56 is shown in its pawl disengaged state, secondary latch mechanism 58 is shown in its ratchet unblocked state, and power actuation mechanism 60 is shown in its actuated state. Note also that pawl lug 96 is in engagement with a raised surface on a third cam segment 98C of control cam surface 98 for mechanically holding pop-up pawl 80 in its ratchet releasing position such that ratchet spring 68 is now permitted to completely rotate ratchet 64 to its striker release position and allow door 16 to move to its open position, thereby completing the power latch release operation. At this point, latch controller 160 terminates rotation of actuation member 140 in the first direction. The ratchet 64 may continue to rotate beyond the point shown in FIG. 11, such that the striker 20 may be fully released.

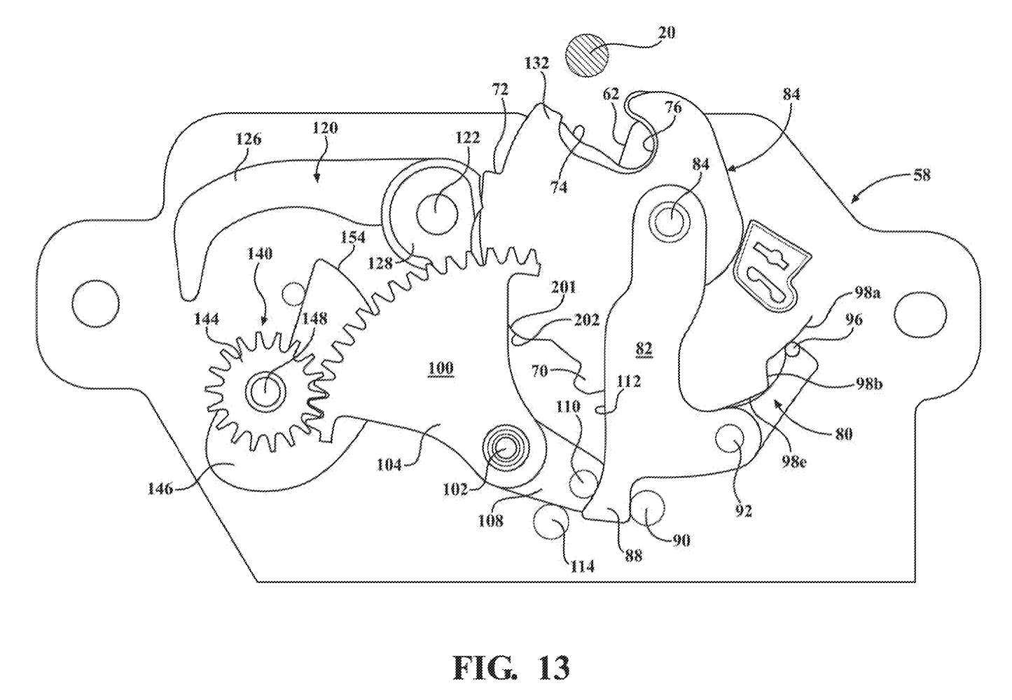

Referring now to FIGS. 12 and 13, a latch reset operation is performed following closure latch assembly 18 being shifted into its Unlatched mode to reset the components in anticipation of a subsequent closing operation (FIGS. 14-17). Specifically, to establish a “Reset” mode for closure latch assembly 18, power actuator 142 is actuated to rotate actuation member 140 in the second or “resetting” (i.e. clockwise) direction, as indicated schematically by arrow 196 from its stop position back to its start position which, in turn causes release lever 100 to rotate (arrow 198) from its actuated position (FIG. 11) back to its home position (FIG. 13).

This rotation of release lever 100 causes drive lug 110 on drive cam segment 108 to engage cam edge surface 112 on pop-up lever 82 and forcibly drive pop-up lever 82 to rotate from its unblocking position (FIG. 11) back to its blocking position (FIG. 13), as indicated schematically by arrow 200. Such movement of pop-up lever 82 causes pawl lug 96 to move from third cam segment 98C to first cam segment 98A of control cam 98, thereby allowing pawl biasing member 94 to forcibly pivot pop-up pawl 80 from its ratchet releasing position (FIG. 11) back to its ratchet holding position (FIG. 13). As described above, the pop-up pawl 80 may pivot or rotate relative to pop-up lever 82, and is biased inward toward control cam surface 98, such that when pawl lug 96 passes point C, the pawl 80 will shift inwardly. When the ratchet 64 is subsequently rotated back to the striker capture position, the primary latch shoulder 70 will pass pawl lug 96, shifting the lug 96 outward temporarily, where the lug 96 and pawl 80 will thereafter shift back inwardly and into engagement with the primary latch shoulder 70.

Note that ratchet 64, when located in its striker release position (FIG. 13), holds crash pawl 120 in its ratchet unblocked position due to edge surface 201 on blocking arm segment 128 sliding along a first ratchet cam surface 202 formed on ratchet 64 between secondary latch shoulder 72 and primary latch shoulder 70, as indicated by circle 204 in FIG. 12. In addition, stop post 114 engages drive cam segment 108 for positively locating release lever 100 in its home position. As previously noted, stop lug portion 88 engages stop post 90 to positively locate pop-up lever 82 in its blocking position. FIG. 13 illustrates closure latch assembly 18 reset into its Reset mode in preparation for ratchet 64 being forcibly rotated by striker 20 to its primary striker capture position in response to door 16 being moved to its fully-closed position.

FIGS. 14-17 illustrate a latch closing operation for shifting closure latch assembly 18 from its Reset mode back into its Latched mode in response to door 16 being closed. Specifically, FIG. 14 illustrates striker 20 engaging striker channel 74 and forcibly rotating ratchet 64 in the closing direction, as indicated schematically by force line 210 and rotary arrow 212. Ratchet 64 is shown having rotated toward the Latched mode relative to its position shown in FIG. 13.

As shown in FIG. 14, blocking arm segment 128 of crash pawl 120 is engaged with secondary latch shoulder 72 on ratchet 64 to provide a secondary latched state when door 16 is moved to a partially-closed position. Primary latch shoulder 70 is yet to translate past pawl 80. Safety latch shoulder 132 is yet to travel past blocking arm segment 128 of crash pawl 120. Pop-up lever 82 and release lever 100 remain in their locations from FIG. 13.

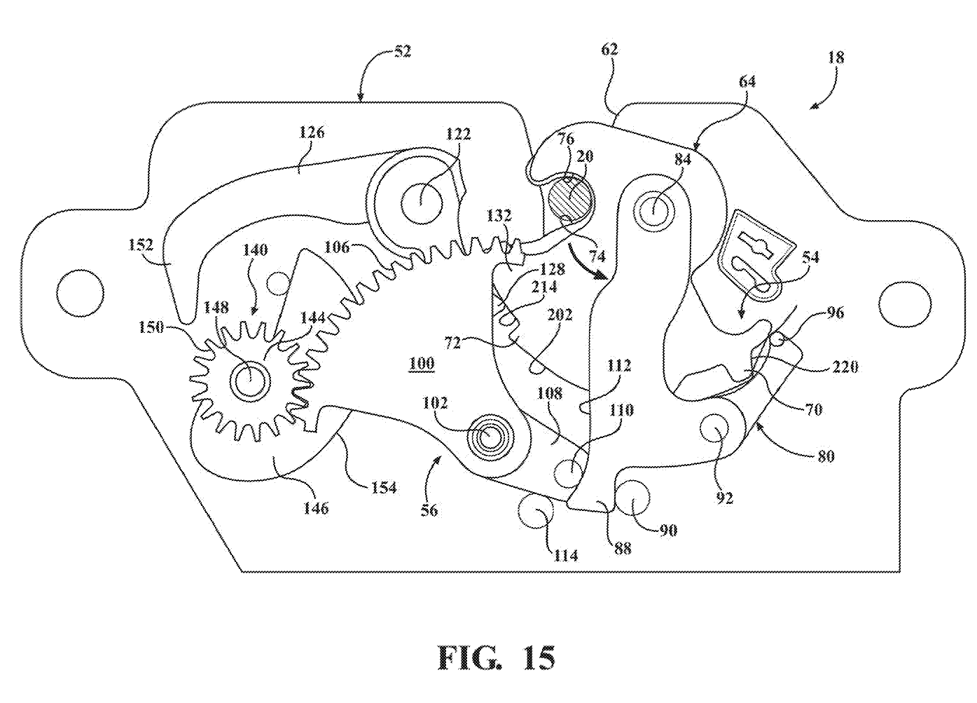

FIG. 15 illustrates striker 20 causing continued rotation of ratchet 64 in the closing direction with blocking arm segment 128 now sliding along a second ratchet cam surface 214 formed on ratchet 64 between secondary latch shoulder 72 and safety latch shoulder 132. Primary latch shoulder 70 has moved further toward popup lug 96 of pawl 80. Blocking arm segment 128 of crash pawl 120 is disposed between secondary latch shoulder 72 and safety latch shoulder 132. Crash pawl 120 is biased against cam surface 214, such that continue rotation will allow crash pawl 120 to ultimately pivot past safety latch shoulder 132 once safety latch shoulder 132 clears blocking arm segment 128.

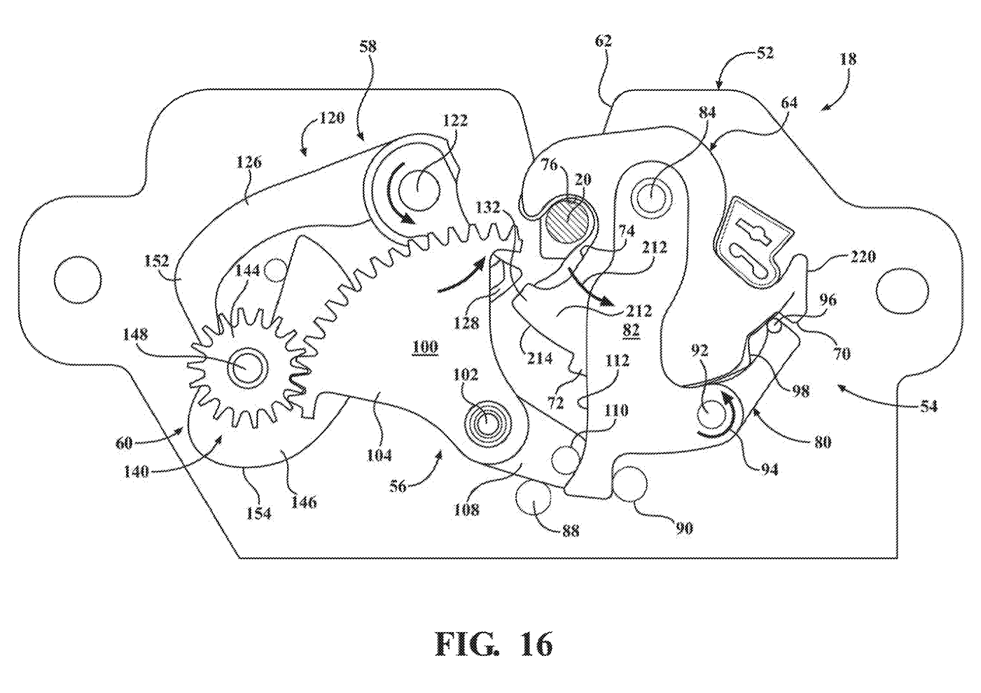

FIG. 16 illustrates continued rotation of ratchet 64 in the closing direction to an “overtravel” position (slightly past its primary striker capture position), whereat blocking arm segment 128 is displaced from safety latch shoulder 132 on ratchet 64, thereby allowing crash pawl biasing member 124 to rotate crash pawl 120 back to its ratchet blocked position. In addition, this rotation of ratchet 64 has caused pawl lug 96 to ride over a third ratchet cam surface 220 formed on ratchet 64 so as to align pawl lug 96 with primary latch shoulder 70. Pop-up pawl 80 moves momentarily out of its ratchet holding position, but pawl biasing member 94 returns pop-up pawl 80 to its ratchet holding position upon release of pawl lug 96 from third ratchet cam surface 220. The gap between the blocking arm segment 128 and safety latch shoulder 132 is once again present after safety latch shoulder 132 has moved past the blocking arm segment 128. In this condition, the crash pawl 120 will block the ratchet 64 from opening, in addition to the pawl 80 blocking the ratchet 64 from opening.

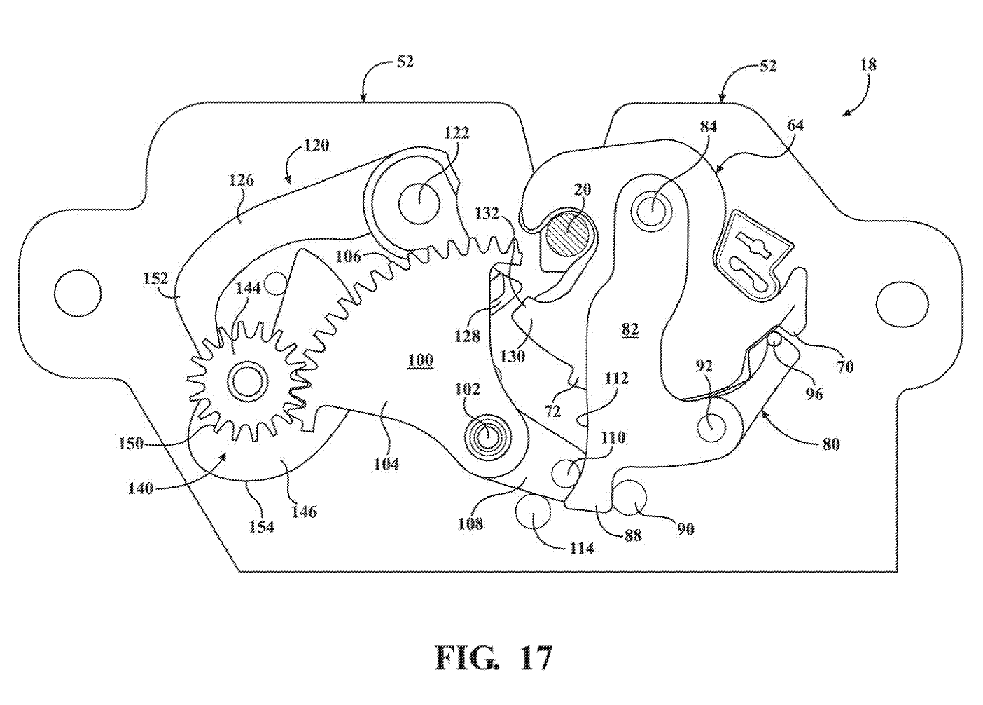

FIG. 17 shows closure latch assembly 18 in its Latched mode, following the overtravel position shown in FIG. 16. The bias on the ratchet 64 causes the ratchet to shift toward its open position, with the primary latch shoulder 70 engaging the pawl lug 96 of the pawl 80. The gap 130 between the ratchet 64 and the crash pawl 120 is present once again. The crash pawl 120 may again by pivoted open to allow the ratchet 64 to open, when desired. The position illustrated in FIG. 17 is similar to the position shown in FIG. 4 as described earlier. A latch opening operation may proceed as shown in FIGS. 4-11.

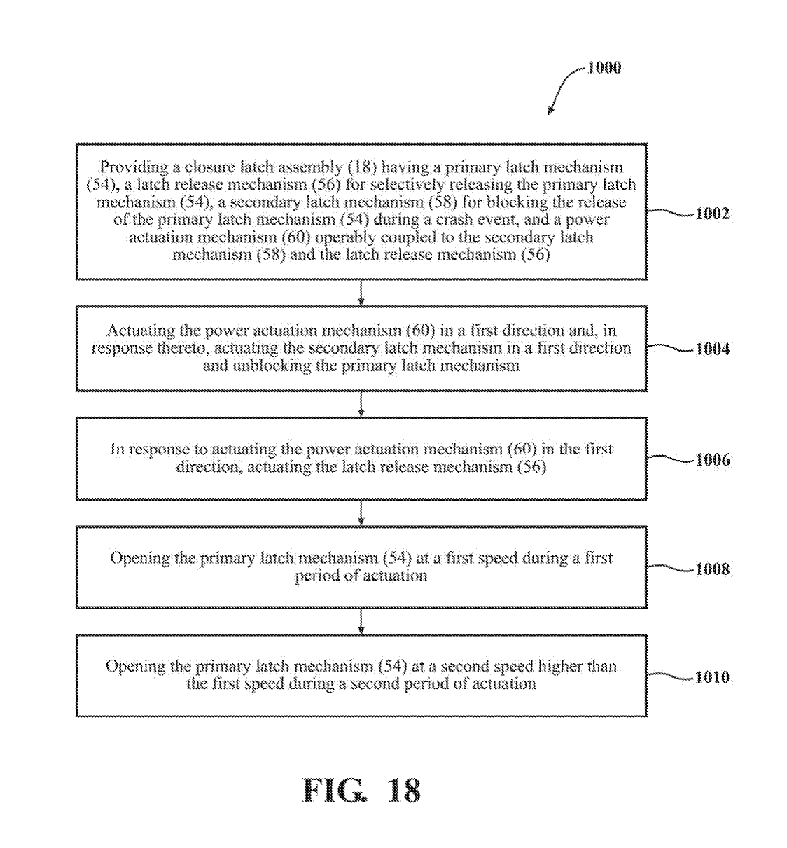

With reference now to FIG. 18, a method 1000 for operating the closure latch assembly 18 is illustrated. It will be appreciated that additional methods or other aspects of the illustrated method may be performed in accordance with the above-described functionality of the various related components.

In one aspect, at step 1002, the method includes providing the closure latch assembly 18 having the primary latch mechanism 54, the latch release mechanism 56 for selectively releasing the primary latch mechanism 54, and optionally releasing the secondary latch mechanism 58 for blocking the release of the primary latch mechanism 54 during a crash event, and the power actuation mechanism 60 operably coupled to the secondary latch mechanism 58 and the latch release mechanism 56.

The method may further include, at step 1004, actuating the power actuation mechanism 60 in a first direction and, in response thereto, actuating the secondary latch mechanism in a first direction and unblocking the primary latch mechanism 54. The method may further include, at step 1006, in response to actuating the power actuation mechanism 60 in the first direction, actuating the latch release mechanism 56.

At step 1008, the method may include opening the primary latch mechanism 54 at a first speed during a first period of actuation. The method may further includes, at step 1010, opening the primary latch mechanism 54 at a second speed higher than the first speed during a second period of actuation.

In one aspect of the method 1000, the primary latch mechanism 54 includes the ratchet 64 having a striker capture position and a striker release position, the pop-up lever 82 having a blocking position and an unblocking position, and the pop-up pawl 80 having a ratchet holding position and a ratchet releasing position. During the first period of actuation, the method 1000 may include moving the pop-up lever 82 from the blocking position to the unblocking position, moving the pop-up pawl 80 from the ratchet holding position to the ratchet releasing position, and moving the ratchet 64 from the striker capture position to an intermediate position. During the second period of actuation, the method 1000 may include moving the ratchet 64 from the intermediate position to the striker release position.

In another aspect of the method 1000, the pop-up pawl 80 includes the pawl lug 96 engaged with primary latch shoulder 70 of the ratchet 64 during the first period of actuation and blocking the ratchet 64. The primary latch shoulder 70 moves past the pawl lug 96 during the second period of actuation.

In another aspect of the method, the secondary latch mechanism 58 includes the crash pawl 120 having a ratchet blocked position and a ratchet unblocked position. The method 1000 may further include moving the crash pawl 120 from the ratchet blocked position to the ratchet unblocked position during the first period of actuation prior to moving the ratchet 64 from the striker capture position.

In another aspect of the method 1000, the power actuation mechanism 60 includes the actuation member 140 engaged with the release lever 100 of the latch release mechanism 56 and a crash pawl 120 of the secondary latch mechanism 58. The release lever 100 is engaged with the pop-up lever 82. Movement of the actuation member 140 causes movement of release lever 100 and associated movement of the pop-up lever 82. Movement of the actuation member 140 further causes movement of the crash pawl 120 and the secondary latch mechanism.

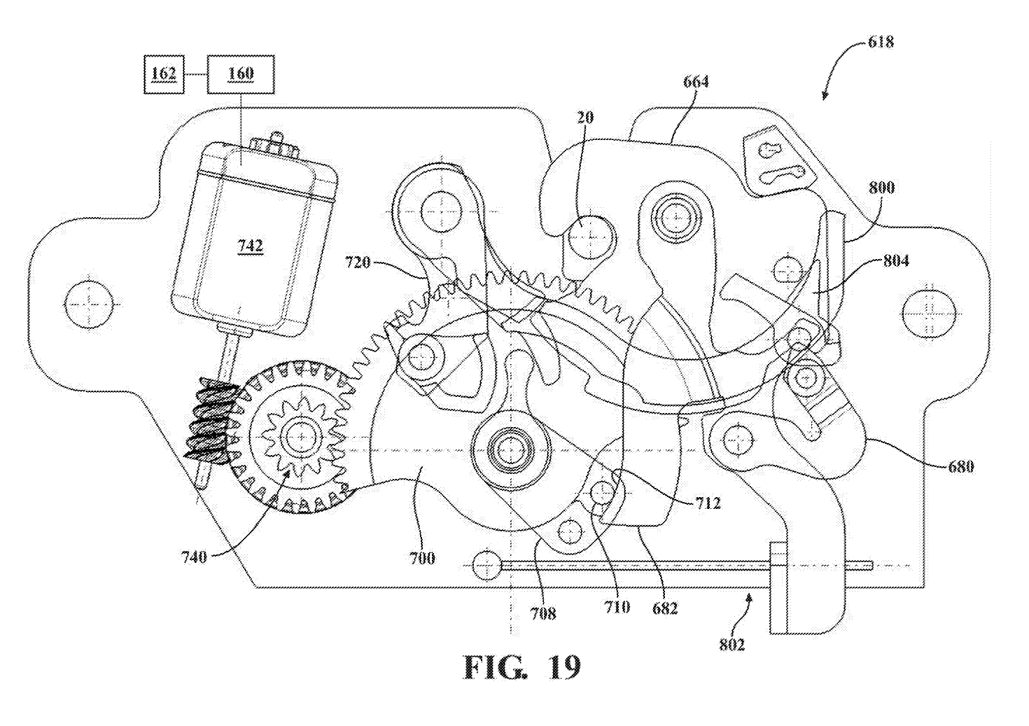

With reference to FIG. 19, in another aspect, an alternative closure latch assembly 618, having various components and features similar to closure latch assembly 18, is shown. Latch assembly 618 may be used in similar closure panels 16 as the latch assembly 18. Latch assembly 618 includes, in addition to providing a “pop-up” feature, also provides a cinching function during closing operations, where the striker 20 is received in the latch assembly 618 and retained, as further described below. As will be apparent to those skilled in the art, a similar component in latch assembly 618 may include similar features and functionality that are not expressly described again in reference to latch assembly 618, with the previous features and functionality of the similar component of latch assembly 18 applying to the corresponding component of latch assembly 618.

With reference still to FIG. 19, the latch assembly 618 includes a ratchet 664, a pop-up lever 682, a pop-up pawl 680, a release lever 700, and a crash pawl 720. The ratchet 664 operates in a similar manner to ratchet 64, where the crash pawl 720 will be actuated to move out of a ratchet blocking position, and the pop-up lever 682 is moved in response to movement of the release lever 100. The pop-up lever will control the movement of the ratchet 664 while the pop-up pawl 80 remains engaged to hold the ratchet 664. Upon sufficient movement of the release lever 700, the pop-up pawl 680 will disengage from its ratchet holding position and allow the ratchet 64 to open fully.

The latch assembly 618 differs from the latch assembly 618 in that the latch assembly 618 further includes an emergency lever 800 and a cinch mechanism 802. As further described below, actuation of the release lever 700 a sufficient amount will engage and actuate the emergency lever 800, with movement of the emergency lever 800 causing movement of the pop-up pawl 680 to disengage from the ratchet 664.

The pop-up pawl 680 provides the ratchet holding function, and further provides a ratchet cinching function. Actuation of the cinching mechanism 802 will operate to force the pop-up lever 682 and pop-up pawl 680 in a ratchet cinching direction. The emergency lever 800 provides a ratchet opening function, in the event the cinching mechanism 802 is in a ratchet cinching position while a ratchet opening movement of the release lever 700 is provided. For example, if the cinching mechanism 802 is stuck, actuation of the release lever 700 will still operate to open the ratchet 664.

The crash pawl 720, similar to crash pawl 120, is actuated in response to actuation of an actuation member 740, which drives release lever 700. However, crash pawl 720 is actuated by a segment of the release lever 700, rather than how crash pawl 120 is actuated by segment 144 of the actuation member 140. As further described below, actuation of actuation member 740 causes release lever 700 to rotate, with different segments of release lever 700 acting on the pop-up lever 682 and the crash pawl 720.

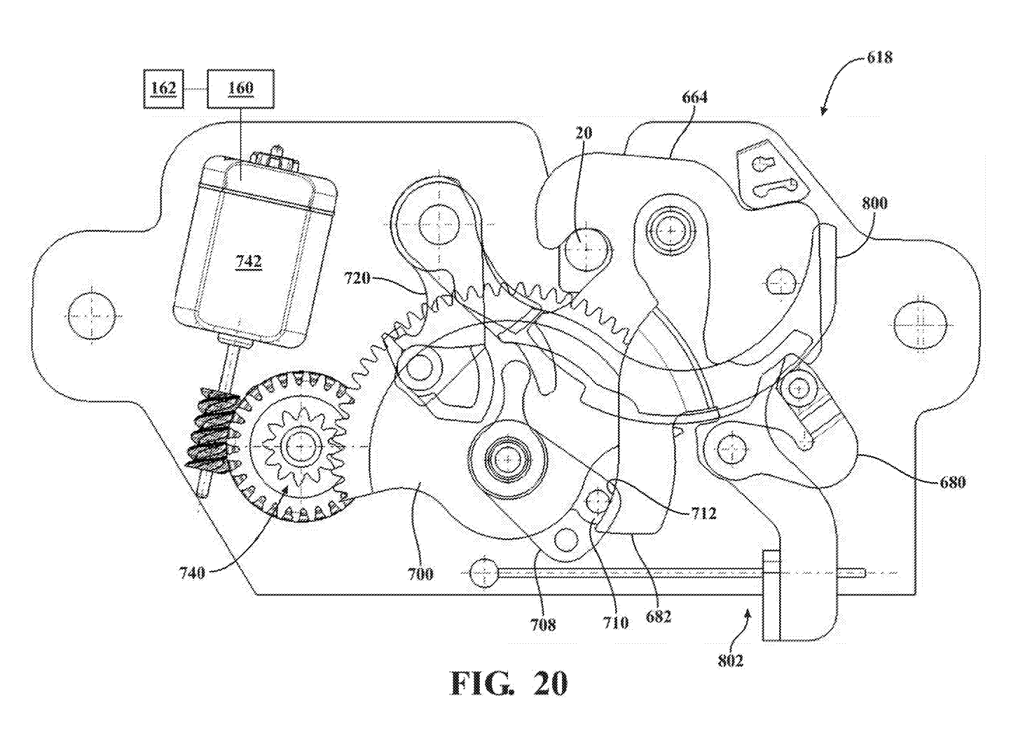

With reference to FIGS. 19 and 20, the latch assembly 618 is shown in a home position, where the ratchet 664 is closed and retaining striker 20. FIG. 20 illustrates a view in which a locking lever 804 (shown in FIG. 19) is removed for clarity, such that the engagement between the pop-up pawl 680 and the ratchet 664 can be more clearly seen. In FIGS. 19 and 20, it can be seen that crash pawl 720 is in a position to block the ratchet 664 from opening, with a small gap shown between them. The release lever 700 is not yet actuated, and a drive cam segment 708 of the release lever having a drive cam post 710 is engaged with a cam surface 712 of pop-up lever 682 and, in particular, curved portion of cam surface 712.

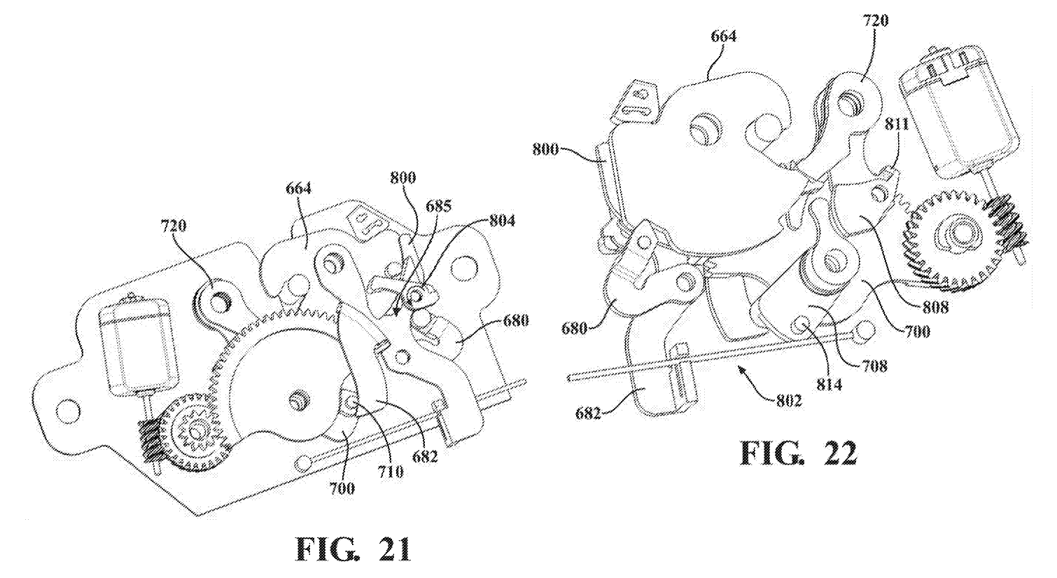

FIGS. 21 and 22 further illustrates the arrangement and engagement of the various components of the closure latch assembly 618. FIG. 21 generally illustrates a front view, similar to the perspective of FIGS. 19 and 20. FIG. 22 generally illustrates a rear view. FIGS. 21 and 22 illustrate further components, described in more detail below in accordance with the functionality of the latch assembly 618 as it is actuated to various states.

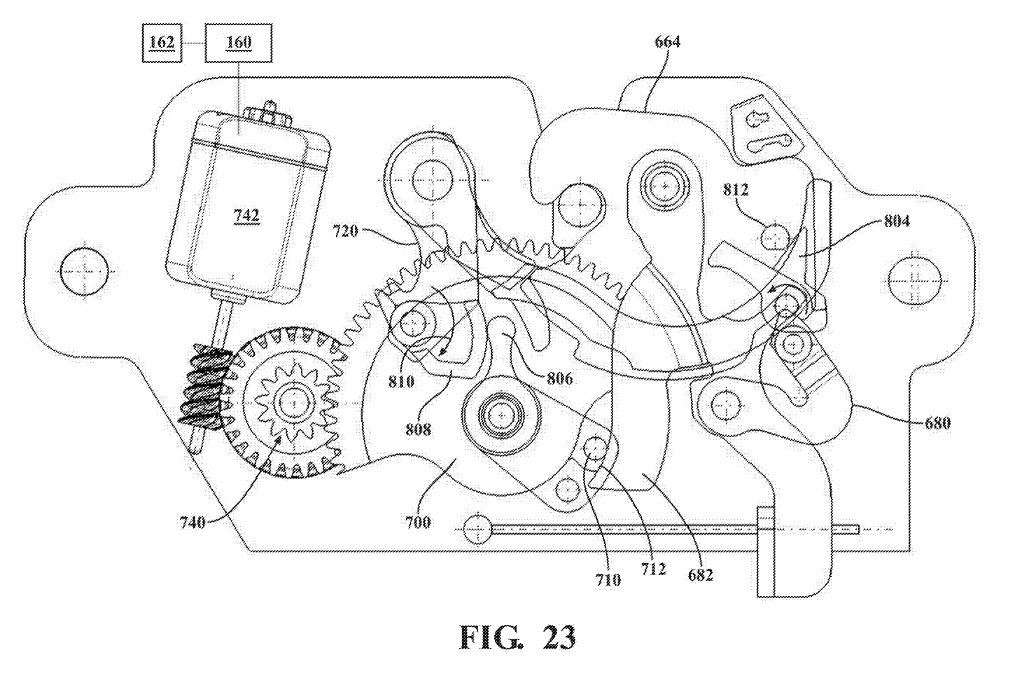

With reference to FIG. 23, in response to actuating the actuator 740, the release lever 700 has rotated, such that a release lever pawl 806 has rotated into engagement with a crash pawl cam portion 808. Crash pawl cam portion 808 is biased in the direction of arrow 810, with a stop surface 811 (FIG. 22) blocking rotation of cam portion 808 in the direction of its bias, while allowing rotation against its bias. Drive cam lug 710 has likewise rotated along with release lever 700, and slides along cam surface 712 of pop-up pawl 682. Pop-up pawl 682 does not rotate at this position, because of the curved portion of cam surface 712. The crash pawl 720, not yet having been rotated, remains in a ratchet blocking position. Also shown in FIG. 23, among other figures, is ratchet lug 812, which extends from ratchet 664, and holds latching lever 804 in place.

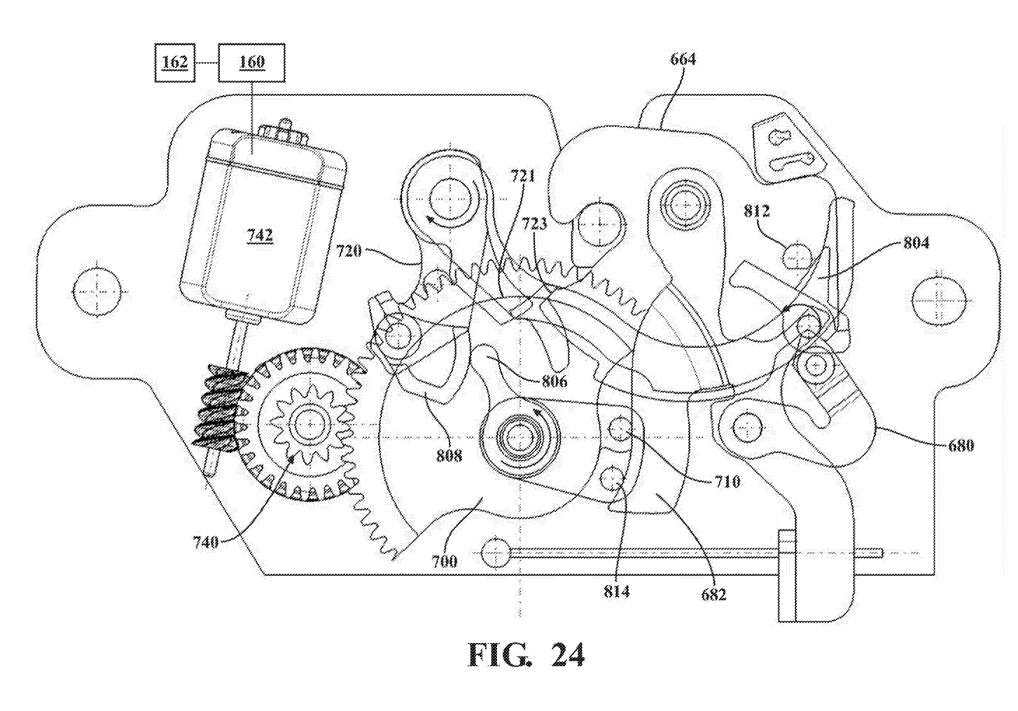

Turning now to FIG. 24, release lever 700 is rotated further, and release lever pawl 806 and drive cam lug 710 have rotated along with the release lever 700. Drive cam lug 710 has reached the straight portion of cam edge surface 712 of pop-up lever 682, such that pop-up release lever 682 may begin to rotate clockwise. Note, release lever 700 also includes drive cam emergency lug 814, which appears to be engaged with pop-up lever 682 in FIG. 24; however, drive cam emergency lug 814 is out of plane with pop-up lever 682 at this location, and does not contact pop-up lever 682 (see FIGS. 21 and 22).

FIG. 24 further illustrates that release lever pawl 806 remains engaged with cam edge surface of crash pawl cam portion 808, thereby pivoting crash pawl 720 clockwise relative to FIG. 23 and moving pawl arm 721 away from a primary locking surface 723 of ratchet 664. Crash pawl 720, at this position, will allow ratchet 664 to open, as crash pawl 720 has moved out of the ratchet blocking position. In FIG. 24, the pop-up lever 682, pop-up pawl 680, and ratchet 664 have just begun moving slowly.

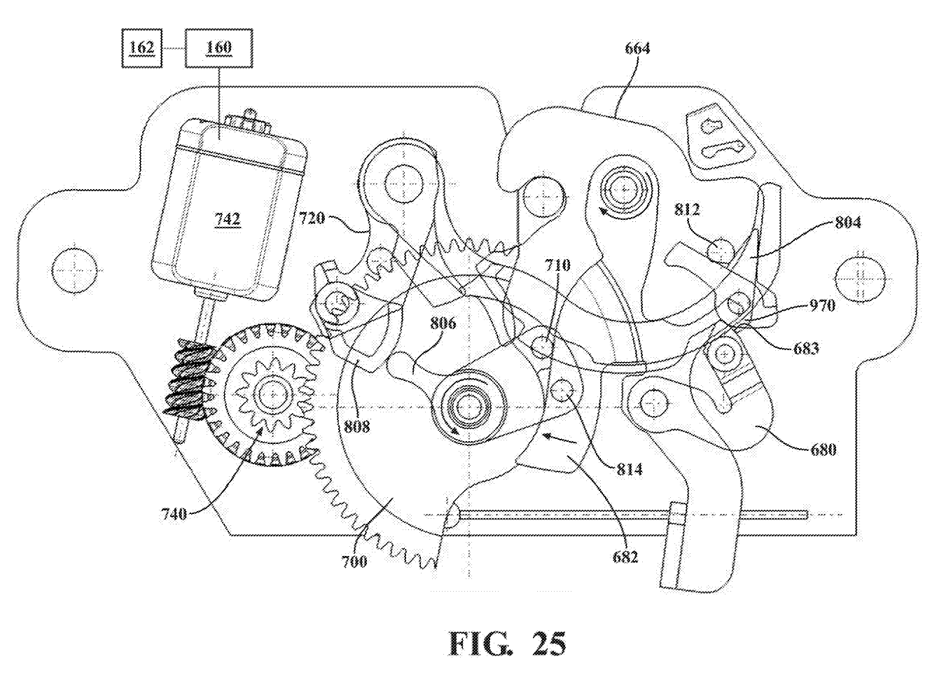

With reference now to FIG. 25, release lever 700 has rotated further counterclockwise, such that pop-up lever 682 and pop-up pawl have rotated further clockwise, allowing ratchet 664 to also rotate further clockwise, for example a cinching pawl control surface 683 of pop-up lever 682 engages a primary latch shoulder 970 of ratchet 664 to resist the opening rotation of the ratchet 664 in accordance with the controlled movement of the pop-up lever 682 against lug 710. Lug 710 has moved counterclockwise relative to FIG. 24 along with release lever 700, such that it has moved upward and to the left, with the edge of pop-up lever 682 following lug 710. Release lever pawl 806 has rotated further along with the release lever 700, thereby further rotating crash pawl 720 via crash pawl cam portion 808. Crash pawl 720 has rotated further relative to ratchet 664, providing further clearance therebetween. With ratchet 664 slowly moving, striker 20 is slowly moving upward.

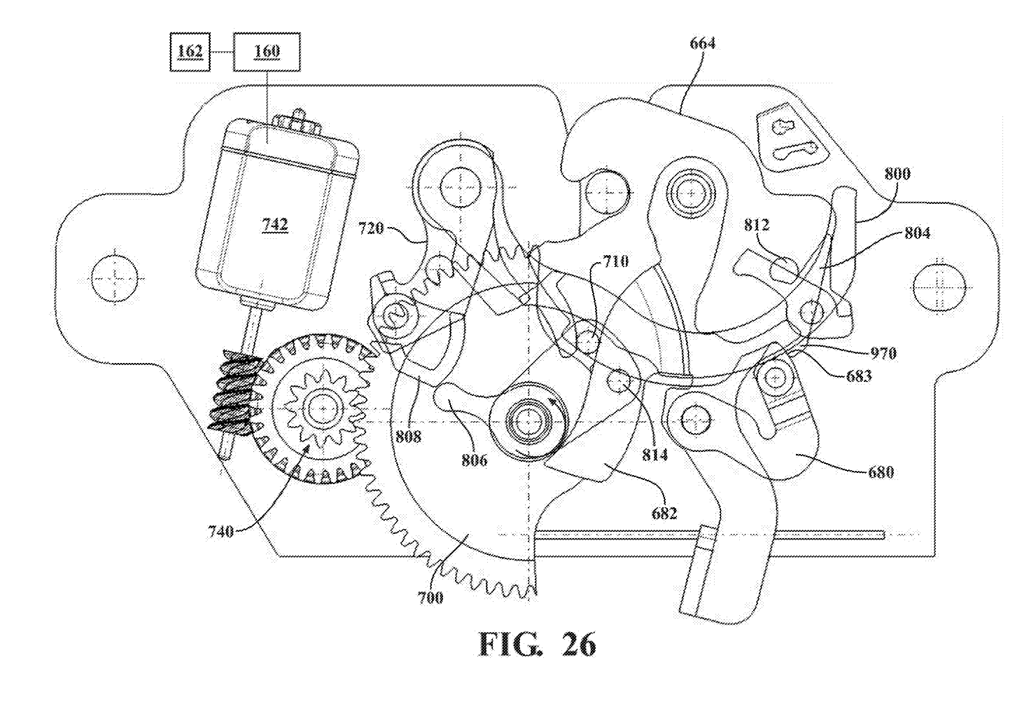

Turning now to FIG. 26, the release lever 700 has rotated further clockwise, and release lever pawl 806 and lug 710 have likewise rotated. Pop-up lever 682 remains in contact with lug 710. Pop-up pawl 680 continues to hold ratchet 664 from releasing fully, for example cinching pawl control surface 683 of pop-up lever 682 remains in blocking engagement with the primary latch shoulder 970 of ratchet 664. Ratchet 664 has moved past crash pawl 720, and crash pawl 720 has been moved to its approximate maximum open position, with release lever pawl 806 having reached the edge of crash pawl cam segment 808.

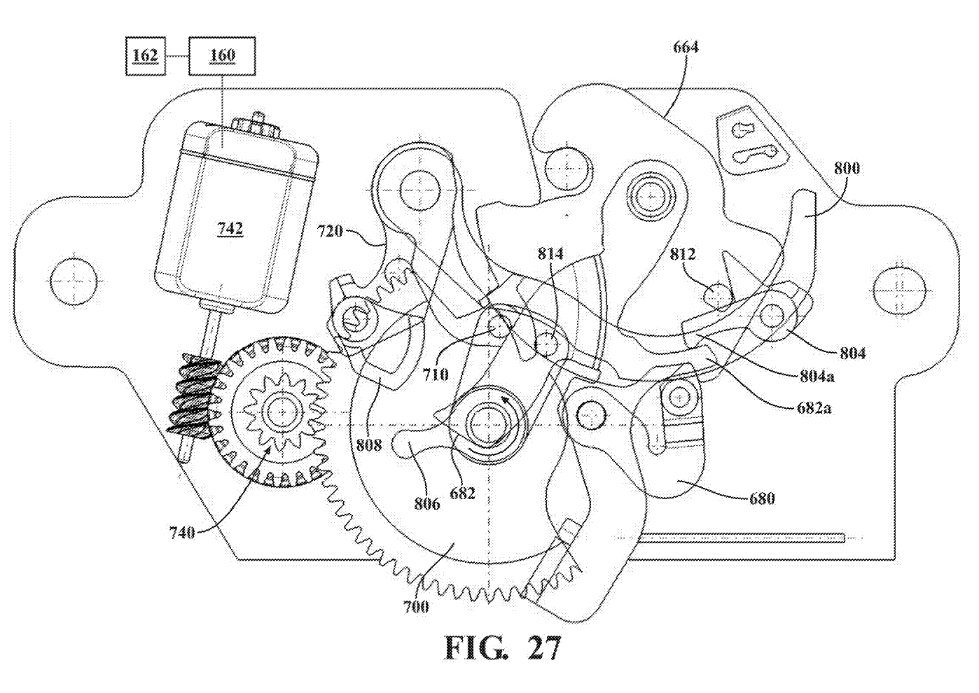

FIG. 27 illustrates further rotation and actuation of the release lever 700, and corresponding further counterclockwise rotation of lug 710 and release lever pawl 806. Release lever pawl 806 has moved beyond crash pawl 720. Pop-up lever 682 has rotated further, remaining engaged with lug 710 as it moves. Pop-up pawl 680 also moves, with ratchet 664 continuing to rotate slowly along with the movement of the pop-up lever 682 and pop-up pawl 680. In this state, ratchet lug 812, moving as the ratchet 664 rotates, has moved sufficiently such that locking lever 804 has rotated counterclockwise. Locking lever 804 includes a leg portion 804a, which comes into contact with cam portion 682a of pop-up lever 682. Locking lever 804 is illustratively biased 685 counterclockwise as illustrated in FIG. 21.

Also shown in FIG. 27, emergency lug 814 has moved sufficiently and come into contact with control contour 818 of emergency lever 800. Further rotation of the release lever 700 will cause movement clockwise of the emergency lever.

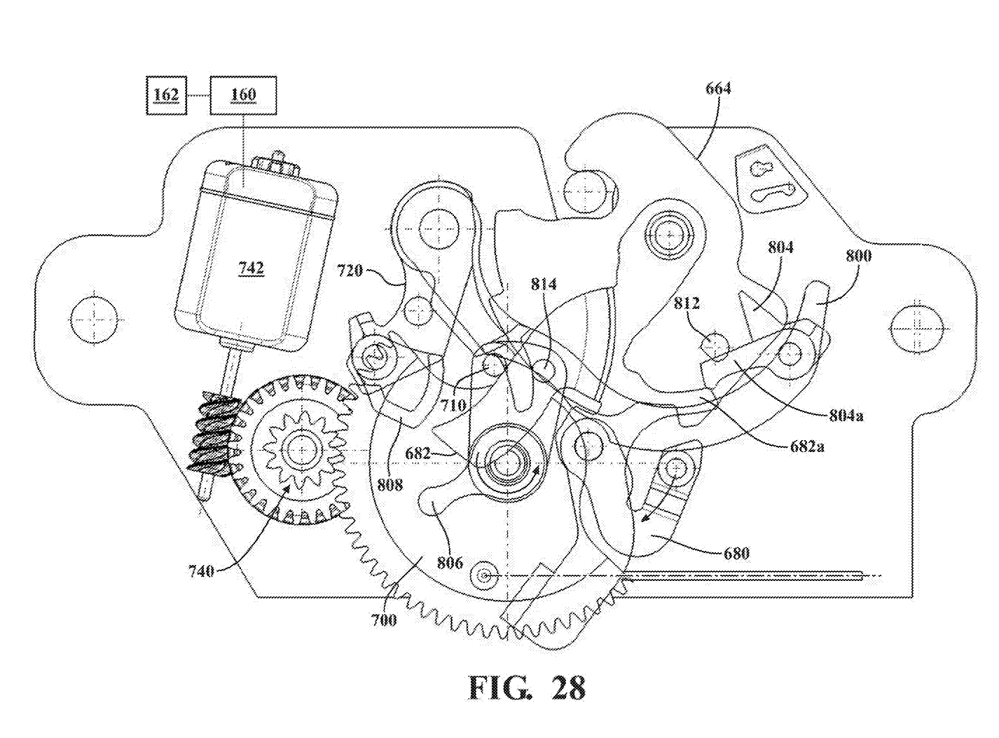

Turning now to FIG. 28, release lever 700 has rotated further, causing emergency lug 814 to act on the edge surface of control contour 818. Emergency lever 800 likewise rotates clockwise, which acts on control pin 822 of pop-up pawl 680. Throughout the previous figures, control pin 822 of pop-up pawl 680 has been sliding along the curved edge of emergency lever 800, which remained in place. Thus, the pop-up pawl 680 remained engaged with the ratchet 664 to bock the ratchet and permit slow rotation of the ratchet 664. With the emergency lever 800 being rotated in response to the emergency lug 814 contacting control contour 818, the emergency lever 800 has pushed pop-up pawl 680 outward and out of engagement with the ratchet 664, allowing the ratchet 664 to open more quickly, as it is no longer restrained by the pop-up pawl 680. The pop-up pawl 680 is rotates relative to pop-up lever 682.

FIG. 28 further shows continued movement of the lug 710 and continued rotation of the pop-up lever 682. As the pop-up lever 682 continues to rotate, the cam portion 682a moves as well, with the leg portion 804a at a tipping point relative to the end of the cam portion 682a. As shown in FIG. 28, crash pawl 720 is resting against the edge of the ratchet 664.

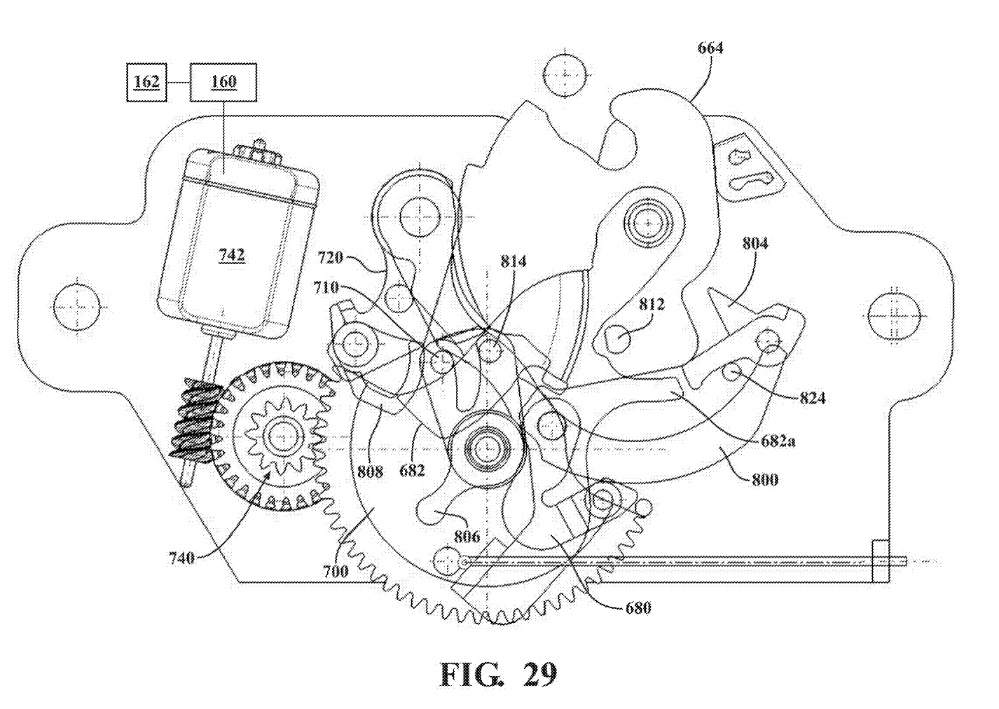

With reference to FIG. 29, the ratchet 664 is shown fully open. The release lever 700 has rotated further, thereby moving lug 710 and emergency lug 814 further. Lug 710 has thereby allowed pop-up lever 682 to further rotate, such that locking lever 804 is unblocked. Locking lever 804 is stopped from rotation by stop face 824, and is in position to block pop-up lever 682 from rotating clockwise. Emergency lug 814 has further moved control contour 818 of emergency lever 800, thereby rotating emergency lever 800 further. The further rotation of emergency lever 800 causes pop-up pawl 680 to move further downward in response to the contact between the emergency lever 800 and control pin 822. Release lever 700 also comes into contact with a stop face 826. The bias (in the form of a traditional return spring) on the release lever 700 in the clockwise direction is at its maximum. The motor powering the actuator 740 is unidirectional and energized in one direction, such that the release lever 700 will rotate back clockwise via the bias, and not via the motor.

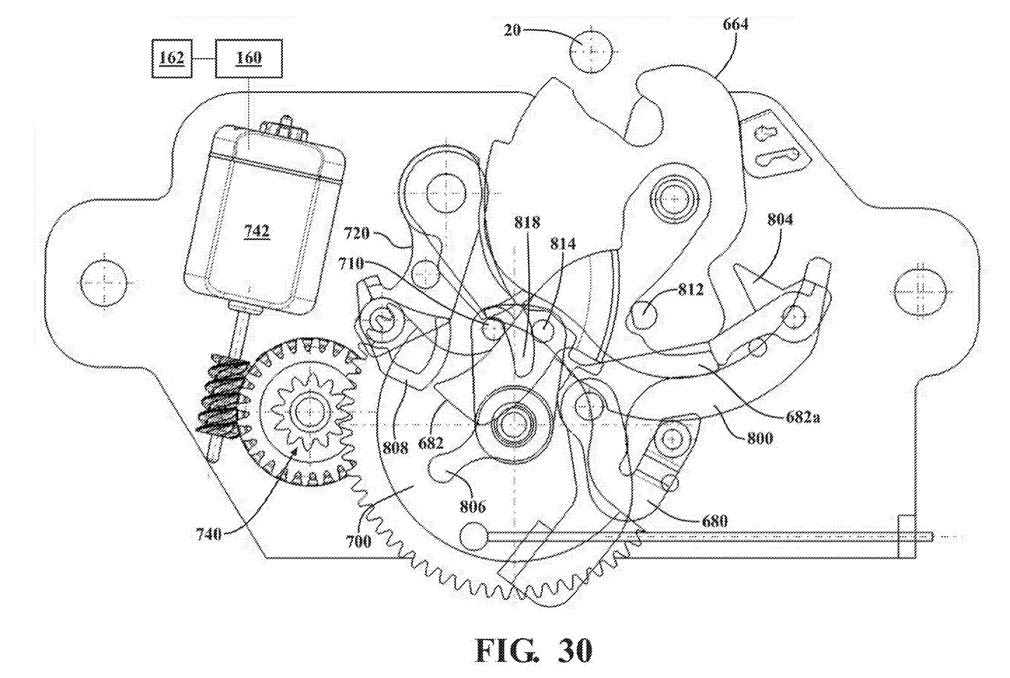

FIG. 30 illustrates a state in which the motor has been switched off, and the release lever 700 begins to rotate back clockwise in response to its bias. The locking lever 804 blocks the cam portion 682a of the pop-up lever 682. Accordingly, the release lever 700 is blocked from further clockwise rotation, with the lug 710 resting against the pop-up lever 682. The pop-up lever 682 is biased counterclockwise, against the locking lever 804. With the release lever blocked, the emergency lever 800 is blocked by the control contour 818 resting against the emergency lug 814. The pop-up pawl 680 rests against the emergency lever 800. The latch assembly 618 may remain in this intermediate position while the ratchet 664 remains open, prepared to receive the striker 20.

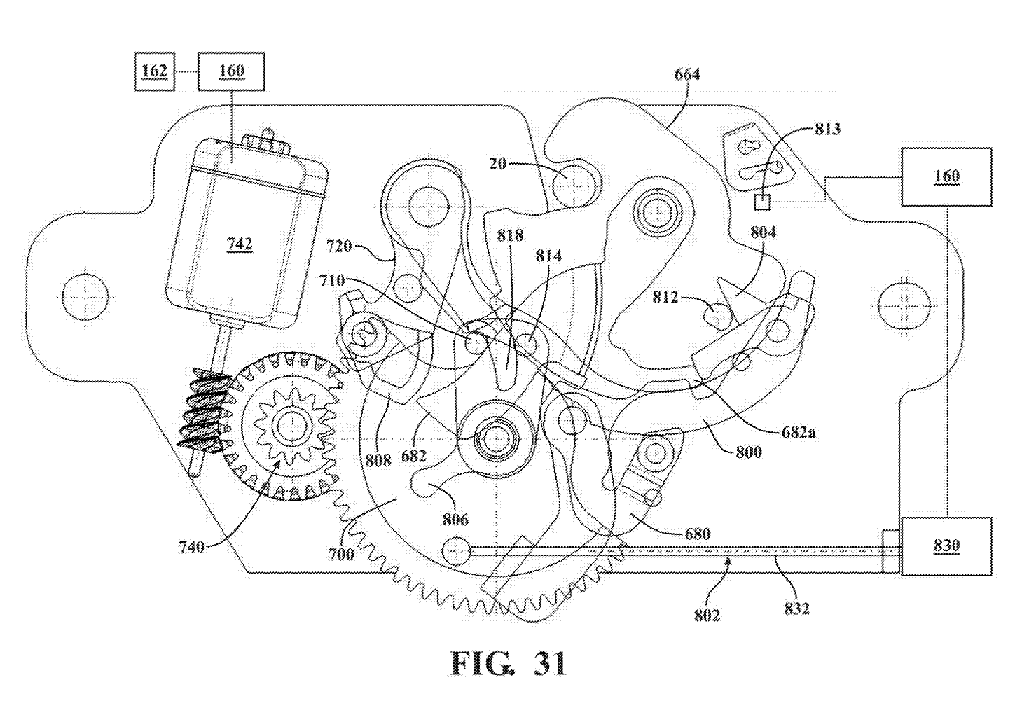

With reference to FIG. 31, the striker 20 is inserted into the ratchet 664, causing the ratchet 664 to close. This is the manual closing portion of a door closing operation. The ratchet 664 is shown in an intermediate position in this view. The ratchet 664 has rotated such that the ratchet lug 812 has come into contact with locking lever 804, which is still blocking cam portion 682a of the pop-up lever 682. As shown in FIG. 31, the pop-up lever 682, release lever 700, emergency lever 800, and pop-up pawl 680 are still being held in the intermediate position shown also in FIG. 30. Further rotation of the ratchet 664 will cause locking lever 804 to move out of its pop-up lever blocking position.

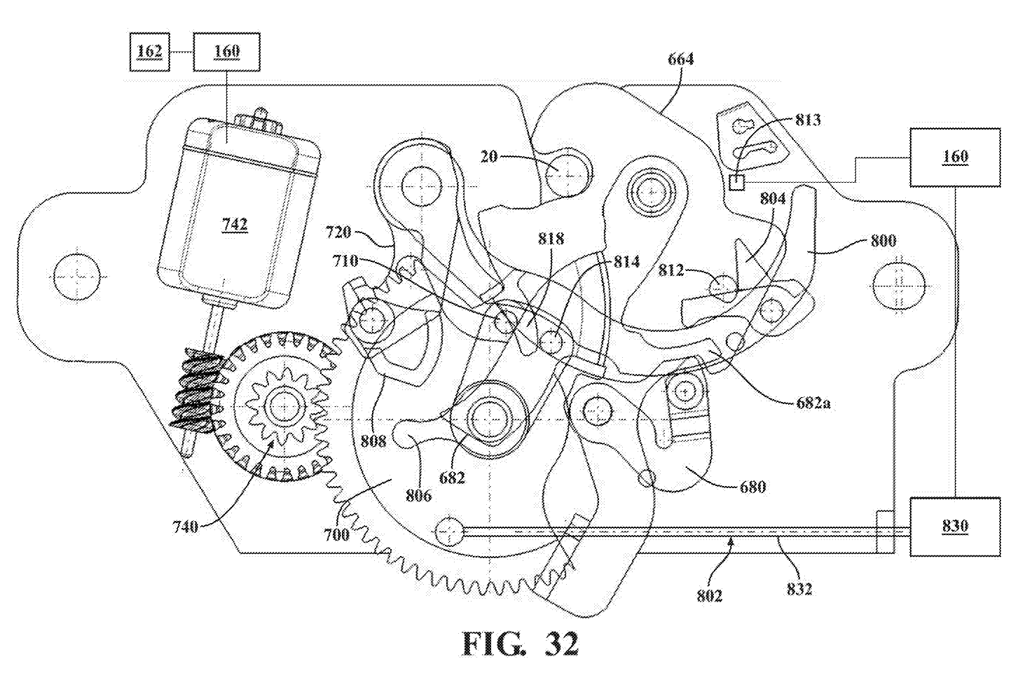

As shown in FIG. 32, the ratchet 664 has rotated further in response to further manual closing of the ratchet 664. The locking lever 804 has been rotated clockwise after being engaged by ratchet lug 812. Pop-up lever 682 has rotated back counterclockwise, allowing lug 710 and emergency lug 814 to move clockwise. Accordingly, release lever 700 has rotated further clockwise, and emergency lever 800 has rotated counterclockwise. In response to the emergency lever having moved counterclockwise, the pop-up pawl 680 moves upward in FIG. 32 and into engagement once again with the ratchet 664, such that the pop-up pawl 680 would block the ratchet 664 from opening. The crash pawl 720 is also blocking the ratchet 664 from opening.

At the position shown in FIG. 32, the cinch mechanism 802 may be actuated to cinch the ratchet 664 further closed. For example a sensor 813, such as a hall sensor may be configured to sense the position of ratchet 664, for example by sensing a magnet provided on the ratchet 664 when the ratchet 664 has reached the secondary striker capture position. A controller, such as latch controller 160, in communication with sensor 813 may be configured to activate a cinch drive 830 to impart a movement to a cinch leg 836 as described herein below. The cinching operation will also allow the release lever 700 to continue to rotate clockwise in accordance with its bias in response to movement of the pop-up lever 682, which continues to block the lug 710 of the release lever 700.

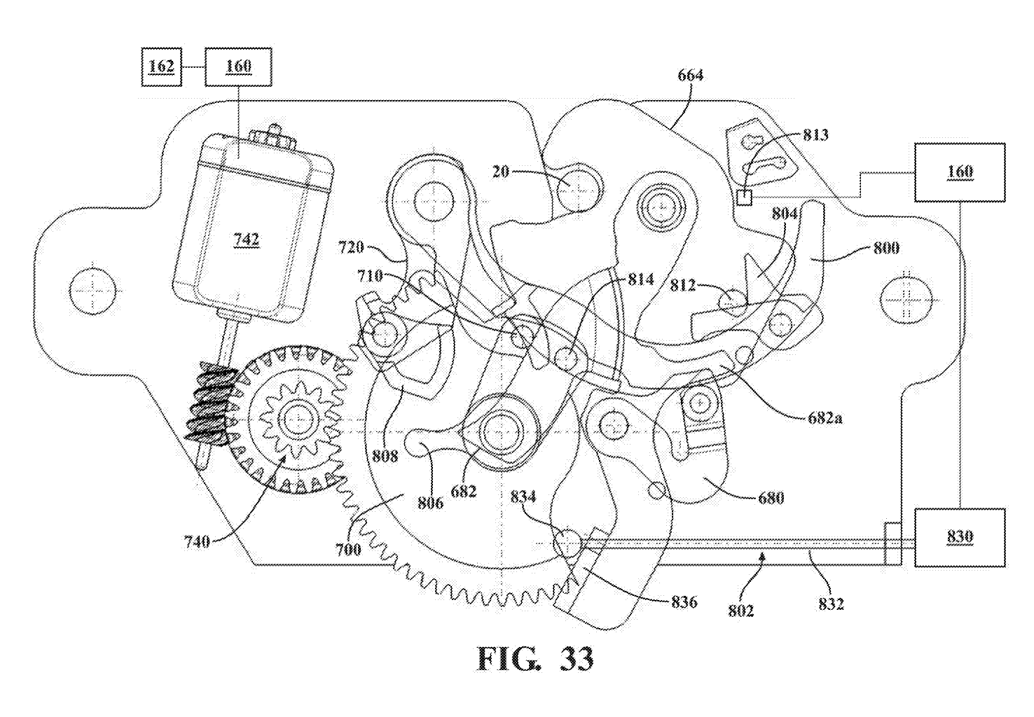

With reference to FIG. 33, cinching mechanism 802 has been actuated. Cinch drive 830 may actuate cinch shaft 832 in a linear direction. Various linear translation mechanisms may be used to drive the shaft 832. A cinch knob 834 is pulled against a chinch leg 836 of the pop-up lever 682. In the position shown in FIG. 33, the cinch knob 836 is about to cause movement of the pop-up lever 682, which will cause movement of the various components being held in place by the pop-up lever 682.

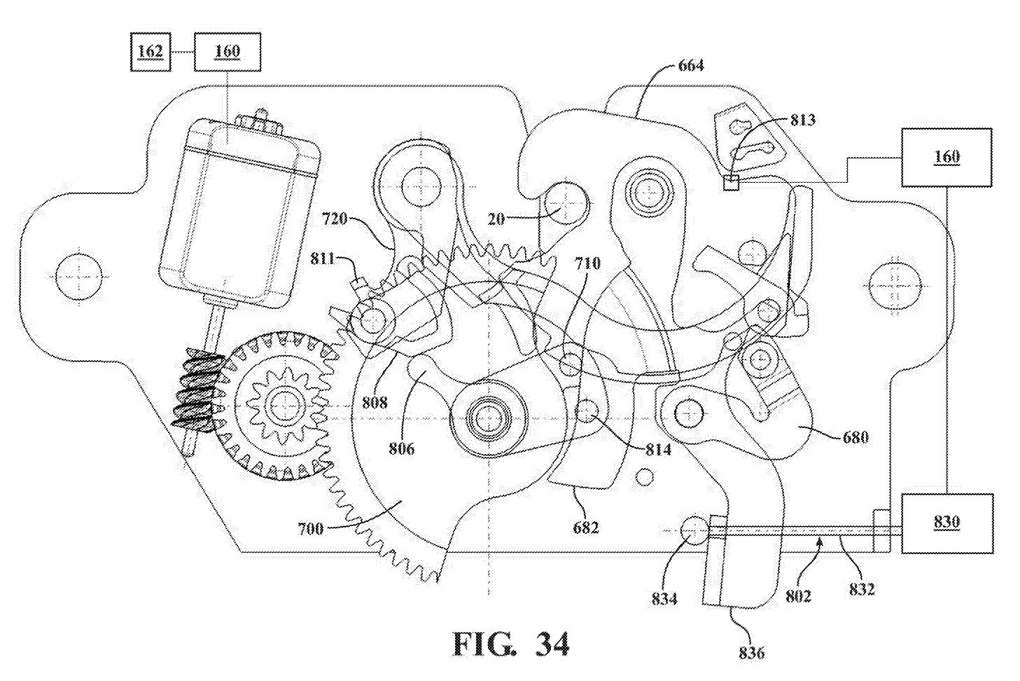

With reference to FIG. 34, the cinch shaft 832 and cinch knob 834 have been moved to the right in FIG. 34 relative to FIG. 33. The pop-up lever 682 and the cinch leg 836 thereof are rotated counterclockwise. In response, pop-up pawl 680 acts on ratchet 664, cinching ratchet 664 closed. As the pop-up lever 682 rotates counterclockwise, the release lever 700 rotates clockwise according to its bias, as lug 710 remains engaged with pop-up lever 682. Rotation of the release lever 700 brings release lever pawl 806 into engagement with cam segment 808 of crash pawl 720. Cam segment 808 will rotate in response away from stop 811, as release lever pawl 806 passes by.

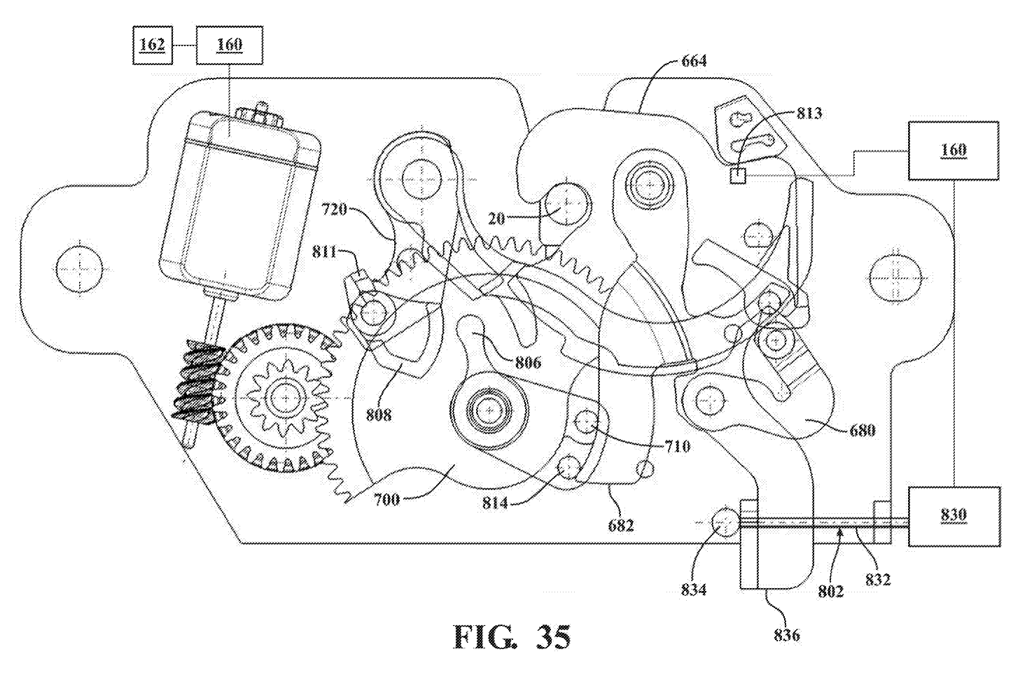

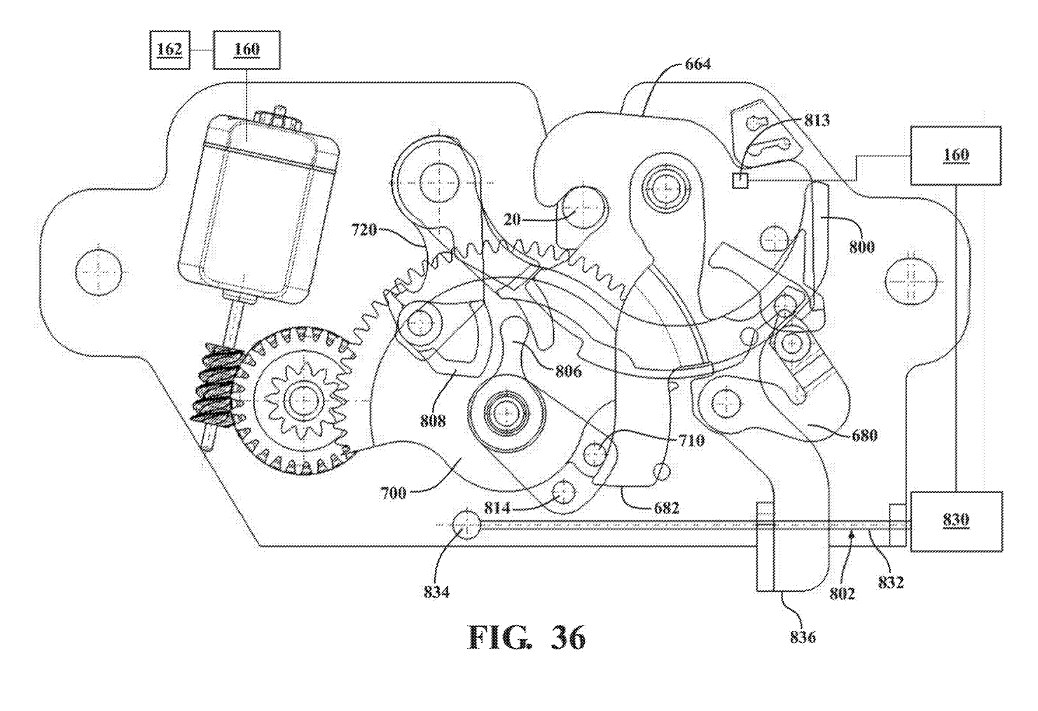

FIG. 35 illustrates additional cinching of ratchet 664 via continued rotation on pop-up lever 682 and cinch leg 836. The pop-up pawl 680 forces ratchet 664 further closed. The additional rotation of pop-up lever allows release lever 700 to rotate back to its rest or home position by reaching the curved edge portion of the pop-up lever 682. Cam segment 808 of crash pawl rotates back clockwise according to its bias, in position to again be contacted by release lever pawl 806 when release lever is rotated counterclockwise during a ratchet opening procedure. Sensor 813, or another sensor, such as a hall sensor may be configured to sense the position of ratchet 664, for example by sensing a magnet provided on the ratchet 664 when the ratchet 664 has reached the overtravel striker capture position shown in FIG. 35 to allow lug 710 to engage with pop-up lever 682 in a position to block pop-up lever 682 from rotating clockwise out of position as shown in FIG. 36 to thereby maintain the closure latch assembly 618 in its latched mode. A controller, such as latch controller 160, in communication with sensor 813 may be configured to deactivate a cinch drive 830 in response to detecting the ratchet 664 reaching the overtravel position.

FIG. 36 illustrates the components back in the home position, with the cinch mechanism 802 returned to a non-cinched position. FIG. 36 therefore resembles FIG. 19. FIG. 36 illustrates a condition where the cinch mechanism 802 has returned to an un-cinched position. However, a door opening command may occur when the cinch mechanism 802 is in a cinched position.

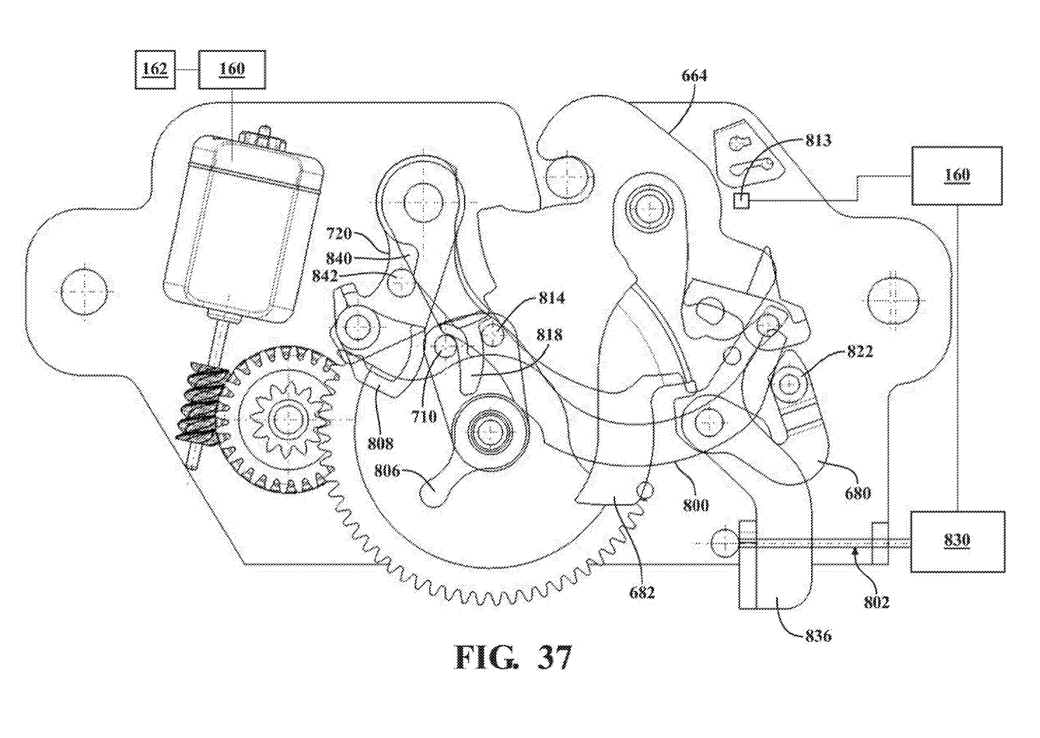

With reference to FIG. 37, an emergency opening situation is illustrated. The cinch mechanism 802 is shown in a cinched position. Accordingly, the pop-up lever 682 is held in position by the cinching mechanism, for example as a result of a failure of the cinch drive 830 maintaining the cinch knob 836 in the counterclockwise position shown in FIG. 37 and preventing return to a position as shown in FIG. 36, such that the pop-up pawl will remain engaged with the ratchet 664, holding the ratchet 664, even in response to an initial rotation by the release lever 700. When the release lever 700 rotates and moves the lug 710, the pop-up pawl 682 will not follow the lug 710. The lug 710 will continue to rotate away from the pop-up lever 682, with the pop-up lever 682 continuing to hold the ratchet 664. The ratchet 664 will therefore not experience a slow opening period.

As the release lever 700 continues to rotate, however the emergency lug 814 will rotate along with it, as described above. Accordingly, when the emergency lug reaches the control contour 818 of the emergency lever 800, the emergency lever 800 will be forced open and will rotate clockwise. Rotation of the emergency lever 800 will force the pop-up pawl 680 out of engagement with the ratchet 664, by the release lever 800 pushing on control pin 812 of pop-up pawl 680.

The emergency lever 800 also operates to open crash pawl 720. As the emergency lever 800 is rotated clockwise by emergency lug 814 of release lever 700, edge portion 840 of emergency lever 800 will contact control pin 842 of crash pawl 720, rotating crash pawl 720 open. With crash pawl 720 opened, ratchet 664 may open fully.

Thus, the emergency lever 800, which is actuated after sufficient rotation of the release lever 700, provides a backup mechanism for opening the ratchet 664, even when the cinch mechanism remains engaged with the pop-up lever 682.

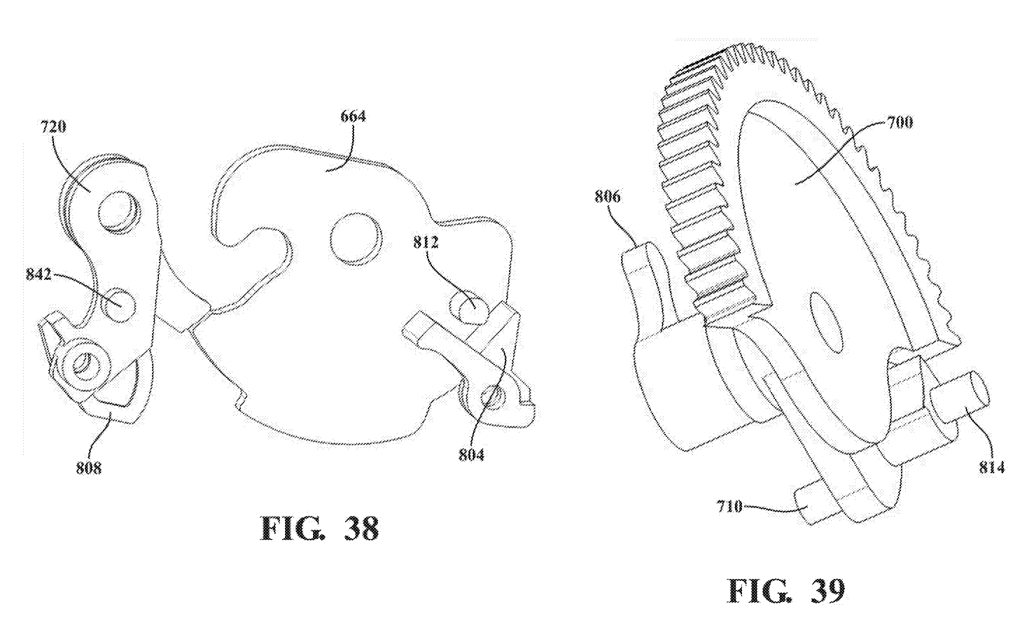

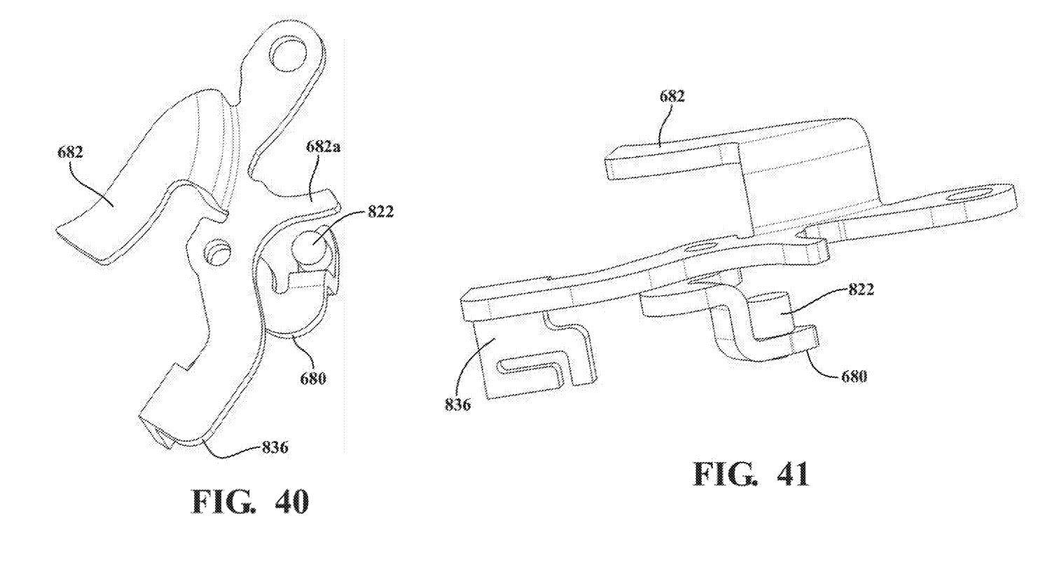

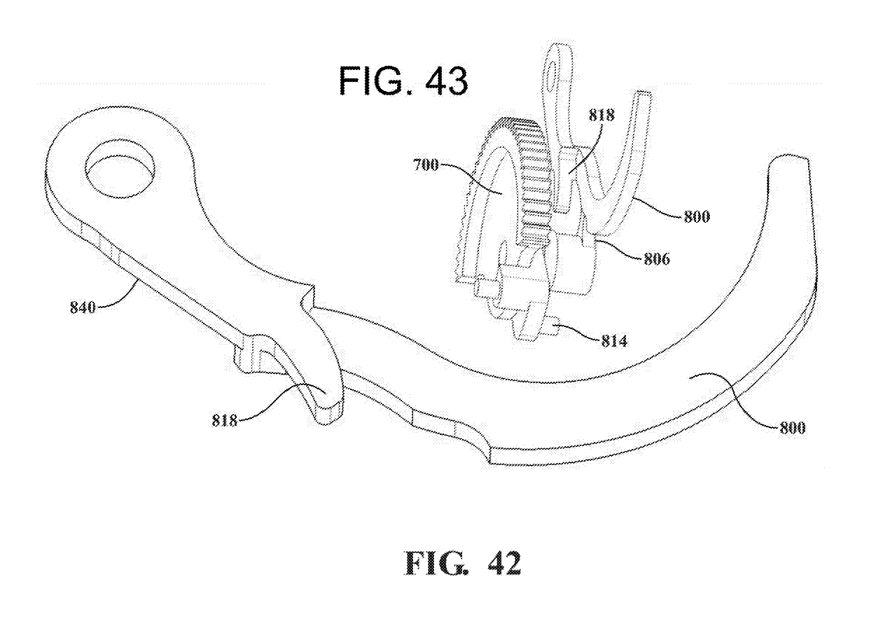

FIGS. 38-43 provide additional perspective views of various components described herein in relation to the closure latch assembly 618, illustrating the different planes of various components, and how various features can interact with corresponding structure in response to movement of select components.

The closure latch assembly 618 provides various benefits. It allows for a soft opening feature as well as a cinching function. The pop-up pawl 680 performs both the pop-up function and the cinching function, thereby allowing for reduction in parts and space. A separate clamping pawl or lever are not necessary. During the emergency opening, the emergency lever 800 unlocks/opens two latches (the pop-up pawl 680 and the crash pawl 720). Moreover, the emergency lever 800 acting on the pop-up pawl 680 therefore provides a control contour instead of the latch housing.

The present disclosure provides a closure latch assembly configured to provide a power latch release function having a soft opening feature capable of progressively reducing the seal loads exerted through the striker on a latch mechanism prior to release of the latch mechanism. This feature, also referred to as a “pop-up” feature, functions to permit limited rotation in a releasing direction of a ratchet associated with the latch mechanism, while still being engaged with a pawl, to reduce the seal loads exerted on the ratchet when the vehicle door is released from its fully-closed position.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A closure latch assembly for a motor vehicle closure system, comprising:
a primary latch mechanism;
a latch release mechanism for selectively releasing the primary latch mechanism;
a secondary latch mechanism for blocking the release of the primary latch mechanism during a crash event; and
a power actuation mechanism operable to initially actuate the secondary latch mechanism to unblock the primary latch mechanism and actuate the latch release mechanism to release the primary latch mechanism.

2. The closure latch assembly of claim 1, wherein a Latched mode is established when the primary latch mechanism is operating in a striker capture state, the latch release mechanism is operating in a pawl engaged state, the secondary latch mechanism is operating in a ratchet blocked state, and the power actuation mechanism is operating in a non-actuated state such that the primary latch mechanism holds a closure panel in a fully-closed position.

3. The closure latch assembly of claim 2, wherein an Unlatched mode is established when the power actuation mechanism is shifted from its non-actuated state into an actuated state for causing the secondary latch mechanism to shift from its ratchet blocked state into a ratchet unblocked state for unblocking the primary latch mechanism and for causing the latch release mechanism to shift from its pawl engaged state into a pawl disengaged state which, in turn, causes a primary latch mechanism to shift from its striker captured state into a striker released state for releasing the primary latch mechanism.

4. The closure latch assembly of claim 3, wherein the power actuation mechanism has an actuation member and a power actuator configured to move the actuation member in a first direction for causing the closure latch assembly to shift from its Latched mode into its Unlatched mode, and wherein movement of the actuation member in a second direction causes the closure latch assembly to shift from its Unlatched mode into a Reset mode.

5. The closure latch assembly of claim 4, wherein movement of the actuation member in the first direction from a start position to an intermediate position results in the secondary latch mechanism shifting from its ratchet blocked state into its ratchet unblocked state, and wherein continued movement of the actuation member in the first direction from its intermediate position to a stop position results in the latch release mechanism shifting from its pawl engaged state into its pawl disengaged state.

6. The closure latch assembly of claim 5, wherein the primary latch mechanism includes a ratchet moveable between a striker release position and a striker capture position, a ratchet spring biasing the ratchet toward its striker release position, a pawl moveable between a ratchet holding position whereat a pawl lug on the pawl engages a latch shoulder on the ratchet for holding the ratchet in its striker capture position and a ratchet releasing position whereat the pawl lug is disengaged from the latch shoulder for permitting the ratchet spring to drive the ratchet toward its striker release position, and a pawl spring biasing the pawl toward its ratchet holding position.

7. The closure latch assembly of claim 6, wherein the latch release mechanism includes a release lever moveable between a home position and an actuated position in response to movement of the actuation member between its start and stop positions, a pop-up lever moveable between a blocking position and an unblocking position in response to movement of the release lever between its home and actuated positions, and a pop-up lever spring for biasing the pop-up lever toward its unblocking position, and wherein the pawl is mounted to the pop-up lever such that movement of the pop-up lever between its blocking and unblocking positions results in corresponding movement of the pawl between its ratchet holding and ratchet releasing positions.

8. The closure latch assembly of claim 7, wherein the primary latch mechanism further includes a control cam in continuous engagement with the pawl lug on the pawl, wherein the control cam is configured to cause the pawl lug to move the pawl between its ratchet holding and ratchet releasing positions in response to movement of the pop-up lever between its blocking and unblocking positions.

9. The closure latch assembly of claim 8, wherein the secondary latch mechanism includes a crash pawl moveable between a ratchet blocked position and a ratchet unblocked position in response to movement of the actuation member between its start position and its intermediate position, and a crash pawl spring normally biasing the crash pawl toward its ratchet blocked position, wherein a blocking arm segment of the crash pawl is aligned with a safety latch shoulder on the ratchet when the ratchet is located in its striker capture position and the crash pawl is located in its ratchet blocked position so as to define the ratchet blocked state of the secondary latch mechanism when the primary latch mechanism is in the striker captured state, and wherein movement of the actuation member from its start position to its intermediate position causes the crash pawl to move from its ratchet blocked position to its ratchet unblocked position such that the blocking arm segment moves to a position displaced from the safety latch shoulder on the ratchet so as to define the ratchet unblocked state of the secondary latch mechanism.

10. The closure latch assembly of claim 9, wherein the actuation member is driven by an electric motor associated with the power actuator and includes a gear segment and a cam segment, and wherein the gear segment is configured to control movement of the release lever and the cam segment is configured to control movement of the crash pawl.

11. The closure latch assembly of claim 1 further comprising a latch controller in operative communication with a power actuator and a signal generating device, wherein the latch controller commands the power actuator to operate the power actuation mechanism in response to receiving a power release signal from the signal generating device.

12. The closure latch assembly of claim 8, wherein the pop-up lever includes a cam edge surface engaged with the release lever, wherein the cam edge surface includes an arcuate portion configured to limit movement of the pop-up lever and pawl during the engagement of the release lever with the arcuate portion of the cam edge surface, and a non-arcuate portion configured to cause movement of the pop-up lever during the engagement of the release lever with the non-arcuate portion of the cam edge surface.

13. A closure latch assembly for a motor vehicle closure system, comprising:
a primary latch mechanism;
a latch release mechanism for selectively releasing the primary latch mechanism; and
a power actuation mechanism operable to open the primary latch mechanism at a first speed during a first period of actuation and opening the primary latch mechanism at a second speed higher than the first speed during a second period of actuation.

14. The closure latch assembly of claim 1, further comprising a cinch mechanism operable between a home position and a cinched position, wherein the cinched position closes the primary latch mechanism.

15. The closure latch assembly of claim 14, further comprising an emergency lever operable to selectively release the primary latch mechanism when the cinch mechanism is in the home position and further operable to selectively release the primary latch mechanism when the cinch mechanism is in the cinched position.

16. The closure latch assembly of claim 15, further comprising:
a pop-up lever with a pop-up pawl coupled thereto, wherein the pop-up pawl selectively holds, releases, and cinches the primary latch mechanism;
a secondary latch mechanism moveable from a blocking position to an unblocking position, wherein in the blocking position the secondary latch mechanism blocks the primary latch mechanism from opening; and
a release lever moveable from a non-actuated position to an actuated position;
wherein, when the cinch mechanism is in the home position, movement of the release lever from the non-actuated position to the actuated position causes movement of the pop-up lever and pop-up pawl to open the primary latch mechanism at the first speed, and further causes movement of the secondary latch mechanism to the unblocking position, and further causes movement of the emergency lever to open the primary latch mechanism at the second speed; and
wherein, when the cinch mechanism is in the cinched position, movement of the release lever from the non-actuated position to the actuated position causes movement of the emergency lever to open the primary latch mechanism and secondary latch mechanism without moving the pop-up lever.

17. A method for operating a closure latch assembly, the method comprising the steps of:
providing a closure latch assembly having a primary latch mechanism, a latch release mechanism for selectively releasing the primary latch mechanism, and a power actuation mechanism operably coupled to the latch release mechanism;
actuating the power actuation mechanism in a first direction and, in response thereto,
in response to actuating the power actuation mechanism in the first direction, actuating the latch release mechanism;
opening the primary latch mechanism at a first speed during a first period of actuation; and
opening the primary latch mechanism at a second speed higher than the first speed during a second period of actuation.

18. The method of claim 17, wherein the primary latch mechanism includes a ratchet having a striker capture position and a striker release position, a pop-up lever having a blocking position and an unblocking position, and a pop-up pawl having a ratchet holding position and a ratchet releasing position, wherein, during the first period of actuation, the method further comprises moving the pop-up lever from the blocking position to the unblocking position, moving the pop-up pawl from the ratchet holding position to the ratchet releasing position, and moving the ratchet from the striker capture position to an intermediate position, and wherein, during the second period of actuation, moving the ratchet from the intermediate position to the striker release position.

19. The method of claim 18, wherein the pop-up pawl includes a pawl lug engaged with a primary latch shoulder of the ratchet during the first period of actuation and blocking the ratchet, wherein the primary latch shoulder moves past the pawl lug during the second period of actuation.

20. The method of claim 19, further comprising providing a closure latch assembly having a secondary latch mechanism for blocking the release of the primary latch mechanism during a crash event, wherein the power actuation mechanism is operably coupled to the secondary latch mechanism, and actuating the power actuation mechanism in a first direction and, in response thereto, actuating the secondary latch mechanism in a first direction and unblocking the primary latch mechanism; wherein the secondary latch mechanism includes a crash pawl having a ratchet blocked position and a ratchet unblocked position, wherein the method further comprises moving the crash pawl from the ratchet blocked position to the ratchet unblocked position during the first period of actuation prior to moving the ratchet from the striker capture position.
